(19) United States
(12) Patent Application Publication
(10) Pub. No.: US 2009/0239459 A1
(43) Pub. Date: Sep. 24, 2009

(54) Self Service Coin Processing Machines With EPOS Terminal And Method For Automated Payout Utilizing Same

(75) Inventors: Gary P. Watts, Buffalo Grove, IL (US); Curtis W. Hallowell, Palatine, IL (US); Marianne Krbec, Wood Dale, IL (US); William J. Jones, Barrington, IL (US); John R. Blake, St. Charles, IL (US); Robert S. Tarragon, Buffalo Grove, IL (US)

Correspondence Address: CUMMINS-ALLISON CORP.;C/O NIXON PEABODY LLP, 300 S. Riverside Plaza, 16th Floor, CHICAGO, IL, 60606, US

(73) Assignee: Cummins-Allison Corp., Mt. Prospect, IL (US)

(21) Appl. No.: 12/404,729

(22) Filed: Mar. 16, 2009

Related U.S. Application Data
(60) Provisional application No. 61/038,044, filed on Mar. 19, 2008.

(51) Int. Cl. G07D 1/00; G07F 9/10

(52) U.S. Cl. 453/18; 221/1; 194/350

(57) ABSTRACT

A method of redeeming coins using a self-service coin redemption machine is provided and includes the act of printing on a blank substrate, using a self-service coin redemption machine printer, indicia associated with a coin processing transaction before the initiation of the coin processing transaction or prior to a completion of a processing of a batch of coins in the self-service coin redemption machine to determine a redemption value thereof. The method also includes the acts of dispensing the substrate, processing a batch of coins in the self-service coin redemption machine to determine a redemption value thereof, and transmitting the redemption value from the self-service coin redemption machine to an EPOS terminal using a communication device. The method further includes inputting the indicia printed on the substrate into the EPOS terminal using a data input device, verifying, using the EPOS terminal, that the indicia input into the EPOS terminal corresponds to an open transaction.

### CROSS REFERENCE

This application claims the benefit of priority from and incorporates herein by reference in its entirety U.S. Provisional Patent Application No. 61/038,044 filed on Mar. 19, 2008, entitled “Self Service Coin Redemption Machines With POS Terminal And Method For Automated Payout Utilizing Same”.

### FIELD OF ENDEAVOR

The present invention relates generally to the field of bulk coin handling systems and, more particularly, to exemplary apparatuses, systems, and methods for bulk coin exchange.

### BACKGROUND

Coin redemption machines are used in banking environments (in patron accessible areas and in employee-only areas), business environments (e.g., armored transport services, telephone companies, etc.) and retail environments, such as grocery stores.

In one example of a coin redemption machine, shown in U.S. Pat. No. 5,564,546, issued on Oct. 16, 1996, and entitled “Coin Counter/Sorter and Coupon/Voucher Dispensing Machine and Method”, a user inputs a batch of coins of mixed denominations into a coin tray of the coin redemption machine. The machine discriminates the coins, determines the value of the valid coins and, subsequent to the completion of the transaction, outputs a “voucher” indicative of the determined amount or a lesser reflecting a commission charged for use of the machine. The user exchanges this “voucher” for currency and/or merchandise. In another example of a coin redemption machine, shown in U.S. Pat. No. 5,982,918, issued on Nov. 9, 1999, and entitled “Automatic Funds Processing System”, a user inputs a batch of coins of mixed denominations into a hopper and the self-service coin processing machine discriminates the coins, determines the value of the valid coins and, subsequent to the completion of the transaction, outputs the determined value, or a lesser reflecting a commission charged for use of the machine or transaction fee, to an output destination selected by the user, the output destinations including, for example, a storage media (e.g., a smart card) or a customer account. In still another example of a coin redemption machine, Scan Coin installed coin redemption machines in the lobbies of banks starting in the late 1980's. The coin redemption machines output a deposit ticket (for deposit) or an exchange ticket (for exchange) and the user was thus permitted to either exchange the exchange ticket for currency or to simply deposit the funds in the form of the deposit ticket.

One disadvantage associated with some conventional coin redemption machines, particularly that of U.S. Pat. No. 5,564,546, noted above, is the potential for fraud which exists with current voucher-based systems. For example, a voucher can be duplicated (i.e., counterfeited) and then exchanged more than once resulting in a loss for that particular store. Additionally, vouchers may be altered, so as to fraudulently increase an apparent value of the receipt in an attempt to obtain more money from the receipt that its true value. Accordingly, as one example, U.S. Pat. No. 6,349,972 to Geiger et al. discloses a coin redemption machine printed voucher comprising various devices to deter, reduce, or eliminate unauthorized duplication or counterfeiting of such voucher, including special inks, papers, indicia, and/or perforations. These security devices, and many others (e.g., holograms, optically variable devices, watermarks, fluorescent fibers, taggants, threads, barcodes, batch and date codes, micro-perforations, etc.), are well known in the negotiable instrument field and have been applied to negotiable instruments in a long-standing struggle to stem losses attributable to counterfeiting and stay ahead of counterfeiters.

Additional disadvantages associated with voucher-based coin redemption machines include, but are not limited to, additional time and steps associated with the redemption process, inconvenience to the bearer of the receipt or the voucher, unfamiliarity with the voucher security features by the clerk or cashier, and human error.

### SUMMARY OF THE DISCLOSURE

The aspects of the present concepts disclosed herein are generally directed to coin exchange machines configured to provide security measures to guard against the unauthorized access and/or use, and to protect against counterfeiting or forging of vouchers or negotiable instruments issued therefrom.

In one aspect of the present concepts, a method of redeeming coins using a self-service coin redemption machine is provided and comprises printing on a blank substrate, using a self-service coin redemption machine printer, indicia associated with a coin processing transaction before the initiation of the coin processing transaction or prior to a completion of a processing of a batch of coins in the self-service coin redemption machine to determine a redemption value thereof. The method also includes the acts of dispensing the substrate, processing a batch of coins in the self-service coin redemption machine to determine a redemption value thereof, transmitting the redemption value from the self-service coin redemption machine to an EPOS terminal using a communication device, inputting the indicia printed on the substrate into the EPOS terminal using a data input device, and verifying, using the EPOS terminal, that the indicia input into the EPOS terminal corresponds to an open transaction. In related aspects, the method includes, for example, the acts of dispensing cash, merchandise, or cash equivalent to the user in an amount corresponding to the redemption value when the indicia input into the EPOS terminal corresponds to an open transaction, and closing the transaction associated with the indicia at least substantially contemporaneously with the act of dispensing.

In one aspect of the present concepts, a method of redeeming coins using a self-service coin processing machine is provided, the method comprising the acts of receiving, via a data input device of a self-service coin processing machine, data input by a user in association with a coin processing transaction, associating the data received from the user with a coin processing transaction, processing, subsequent to the acts of receiving and associating, a batch of coins input into the self-service coin processing machine to determine a redemption value thereof, and transmitting the redemption value from the self-service coin processing machine to an EPOS device using a communication device. The method further includes the acts of inputting, via a data input device associated with the EPOS device, the data previously input by the user at the self-service coin processing machine in association with a coin processing transaction, identifying the coin processing transaction corresponding to the data input by the user in association with the coin redemption transaction, and verifying, using the EPOS device, that the data input into the EPOS device corresponds to an open transaction. The method may further include the act of dispensing cash, merchandise, or cash equivalent to the user in an amount corresponding to the redemption value when the data input into the EPOS terminal corresponds to an open transaction. The method may further include the act of closing the transaction associated with the data at least substantially contemporaneously with the act of dispensing.

In another aspect of the present concepts, a system for redeeming coins comprises a self-service coin processing machine configured to process batches of input coins and to determine a redemption value thereof, the self-service coin processing machine comprising a controller, a display, a printing device, and a communication device, the controller being configured to generate a random number prior to or during a coin processing transaction, to cause the printing device to print the random number on a substrate and dispense the substrate bearing the random number to a user of the self-service coin processing machine prior to or during a coin processing transaction, to determine a redemption value of the input batch or batches of coins, and to cause the communication device to transmit the random number to an EPOS system in association with the transaction information comprising the redemption value, the EPOS system comprising a controller, a memory device, a communication device, and an EPOS terminal including a display device and a data input device. The EPOS system is configured to maintain in the EPOS system memory device a database comprising transaction information for open transactions, to receive data input into the data input device, to compare the data input into the data input device against the transaction information for open transactions maintained in the EPOS system memory device database, and to verify that the data input into the EPOS terminal data input device corresponds to an open transaction.

In still another aspect of the present concepts, a system for redeeming coins comprises a self-service coin processing machine configured to process batches of input coins and to determine a redemption value thereof, the self-service coin processing machine comprising a controller, a display, a printing device, a communication device, and a first data input device, the controller being configured to enable the processing of a batch of coins input by a user following input of user identification information by the user into the first data input device, the controller being further configured to cause the communication device to transmit the user identification information to an EPOS system, to determine a redemption value of the input batch or batches of coins, and to cause the communication device to transmit the redemption value to the EPOS system in association with the user identification information, the EPOS system comprising a controller, a memory device, a communication device, and an EPOS terminal including a display device and a second data input device. The EPOS system is configured to maintain in the EPOS system memory device a database comprising transaction information for open transactions, to receive user identification information input into the second data input device, to compare the user identification information input into the second data input device against the transaction information for open transactions maintained in the EPOS system memory device database, and to verify that the data input into the second data input device corresponds to an open transaction.

In another aspect, a system for redeeming coins includes a self-service coin processing machine configured to process batches of input coins and to determine a redemption value thereof, the self-service coin processing machine comprising a controller, a display, a printing device, and a communication device, the controller being configured to generate a random number following completion of a coin processing transaction, to determine a redemption value of the input batch or batches of coins, to cause the printing device to print the random number on a substrate and dispense the substrate bearing the random number to a user of the self-service coin following the completion of the coin processing transaction, to cause the communication device to transmit the random number to an EPOS system in association with transaction information comprising the redemption value, the EPOS system comprising a controller, a memory device, a communication device, and an EPOS terminal including a display device and a data input device. The EPOS system is configured to maintain in the EPOS system memory device a database comprising transaction information for open transactions, to receive data input into the data input device, to compare the data input into the data input device against the transaction information for open transactions maintained in the EPOS system memory device database, and to verify that the data input into the EPOS terminal data input device corresponds to an open transaction.

The present concepts are not intended to be limited to the particular combinations and elements disclosed above, but rather may include any combination of any of the concepts and elements disclosed herein.

### BRIEF DESCRIPTION OF THE DRAWINGS

Other objects and advantages of the invention will become apparent upon reading the following detailed description in conjunction with the drawings.

FIG. 1 shows aspects of a coin redemption system in accord with at least some aspects of the present concepts.

FIG. 2(a) shows aspects of a method and system in accord with at least some aspects of the present concepts.

FIG. 2(b) shows aspects of a method and system in accord with at least some aspects of the present concepts.

FIG. 3 shows aspects of a method and system in accord with at least some aspects of the present concepts.

FIGS. 4(a)-(h) show aspects of a method and system in accord with at least some aspects of the present concepts.

FIGS. 5(a)-(f) show aspects of a method and system in accord with at least some aspects of the present concepts.

FIGS. 6(a)-(f) show examples of records generated in accord with aspects of methods and systems in accord with the present concepts.

FIG. 7 shows aspects of a method and system in accord with at least some aspects of the present concepts.

FIG. 8 shows aspects of a method and system in accord with at least some aspects of the present concepts.

FIG. 9 shows an example of a manager summary report in accord with at least some aspects of the present concepts.

FIG. 10 shows aspects of a method and system in accord with at least some aspects of the present concepts.

FIGS. 11(a)-(h) show aspects of a method and system in accord with at least some aspects of the present concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present concepts are directed to providing an automated and secure method of putting cash or other value into the hands of the user using self service coin redemption machines, while providing more security to the owner of the equipment. The present concepts also provide quicker and more accurate balancing procedures for the cashier, teller or manager than offered with receipt only based transactions.

The above product concepts are described herein in an embodiment wherein a self service coin (SSC) redemption machine, such as the Cummins-Allison “JetSort” or “Money Machine™”, is communicatively associated with a Point-of-Sale (POS) device disposed at the cashier/teller station, service desk, or other location. POS devices come in a variety of shapes, sizes and functions and typically refer to small devices placed on the counter at retail outlets for enabling payment transactions such as credit or debit card payments. They may comprise “wired” as well as “wireless” connectivity options and may include signature pads, touch pads and pin pads. POS manufacturers provide developers tool kits to allow third parties developers to use them for a variety of purposes. The EPOS device associated with the SSC machine may comprise not only a conventional POS device, such as a VeriFone POS terminal, or any other electronic POS device (an EPOS) including, but not limited to a computer or computing device, configured to offer functionality similar to a standard POS or enhanced functionality/options in accord with the additional flexibility offered by such platforms and I/O devices. Thus, the term “EPOS device” or “EPOS terminal” will be used herein to include not only conventional POS devices, but is also to be construed to generally include other classes and types of computers and computing devices that are configurable to permit at least the functionality described herein.

Coin processing machines suitable for use with the present concept include, but are not limited to, those disclosed in U.S. Pat. Nos. 6,996,263 B2, 6,892,871, 6,896,118 B2, 6,810,137 B2, 6,755,730, 6,748,101 B1, 6,731,786 B2, 6,724,926 B2, 6,678,401 B2, 6,609,604, 6,603,872 B2, 6,579,165 B2, 6,318,537 B1, 6,171,182, 6,068,194, 6,039,645, 6,021,883, 5,997,395, 5,982,918, 5,943,655, 5,905,810, and 5,564,974, each of which is incorporated herein by reference in its entirety. Alternatively, coin processing machines, such as but not limited to those that are disclosed in U.S. Pat. Nos. 5,564,546 and 5,799,767, may also be used in accord with the present concepts.

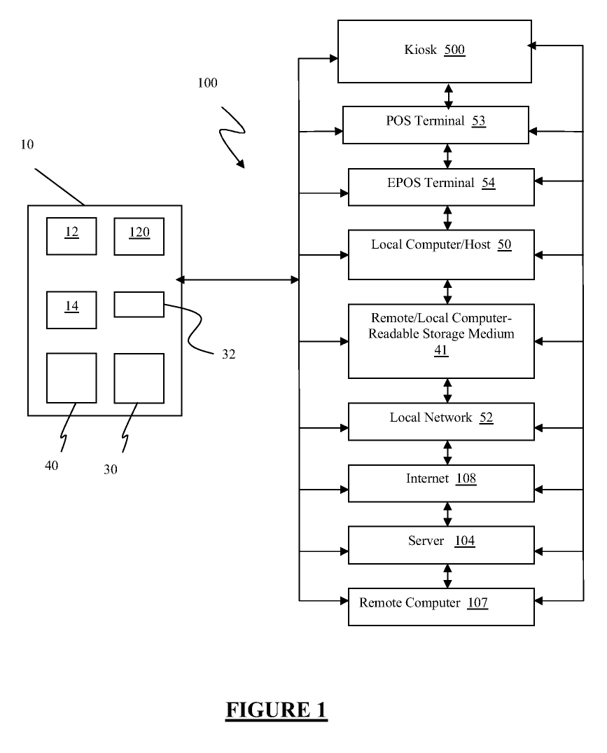

An exemplary self-service coin processing redemption system 100 is shown in FIG. 1 and comprises a self-service coin processing machine 10 configured to receive a plurality of coins in an input region 14, such as by a coin tray or coin hopper configured to receive a batch of input coins, and to process the coins to determine a value thereof and optionally to determine a redemption value thereof. The redemption value is the determined value of the coins minus any applicable transaction charges or fees. If there are no transaction charges or fees imposed, the entire determined value would be returned to the user. A user input device (e.g., a touch screen 12, buttons, biometric input device, etc.) is configured to receive an input of a user and a controller 30 is configured to control the coin processing transaction. Alternatively, the controller 30 may be locally or remotely disposed and need not necessarily be disposed within or even near the self-service coin processing machine 10.

Communication device 120 is configured to output transaction related data, such as the value of the processed coins or a redemption value related thereto and a PIN assigned to the transaction, to a self-service coin processing machine 10 computer-readable storage medium 40, a local or remote computer-readable storage medium 41, a local computer/host 50, a local network 52, the internet 108, a server 104, a remote computer 107, a POS terminal 53, or an EPOS terminal 54. The communication device 120 could comprise, for example, one or more of a modem, Ethernet port, Ethernet card, a wireless device (e.g., IR device, RF device, broadband, etc.), a serial port, parallel port, USB port, ECP port, IEEE 1394 port, 10b-T port, broadband device and/or any other conventional communication device. Via the communication device 120, the self-service coin processing machine 10 may advantageously transmit a portion of or all of the redemption value using the communication device and an associated communication path to an account designated by the user by input of account data using a key pad, touch keys, card reader (e.g., by input or swiping of a magnetic strip bearing card or IC card), or receiving device (e.g., RF device reader) comprise a currency dispenser, stored value media dispenser, check dispenser, and/or other device by which all of, or some of, the redemption value may be directly dispensed to the user.

The self-service coin processing machine 10 includes a user identification record printer 32 configured to print a user identification record bearing instructions to the user as well as a PIN associated with the transaction. As noted herein, the user identification record is advantageously printed before or during the processing of the coins (or alternatively after the processing of the coins) by the self-service coin processing machine 10 user identification record printer 32. In some aspects of the present concepts, however, the user is permitted to input a code via an input device (e.g., button panel, biometric input device, touch screen, etc.) of the self-service coin processing machine 10 to provide a receipt-less redemption system wherein the user is able to receive their payment from the coin redemption machine, teller, cashier or automated payment device, or combinations thereof, without requiring a printed receipt. In this regard, it is to be noted that the self-service coin processing machine 10 may advantageously comprise a currency dispenser, stored value media dispenser, check dispenser, and/or other device by which all of, or some of, the redemption value may be directly dispensed to the user by the self-service coin processing machine.

In at least some aspects, a self service coin redemption system 100 in FIG. 1 comprises a self-service coin processing machine (“the SSC machine”) and EPOS terminal 54 disposed at the cashier/teller station, a service desk, at the self-service coin processing machine, or at a kiosk. The EPOS terminal 54 has memory logic and is connected to the SSC machine directly (e.g., a hardwired or wireless connection) or indirectly (e.g., through a server, network, service, etc., via a hardwired or wireless connection). The EPOS terminal 54 may comprise a discrete EPOS terminal, or may be functionally integrated with other devices (e.g., a kiosk). For example, a given site in which the SSC machine is deployed may comprise a network to which a plurality of POS terminals and the SSC machine are connected. The EPOS terminal 54 contains or is associated with a memory adapted to store all transactions coming from the data sent (e.g., via stream or burst transmissions) by the SSC machine. The SSC machine advantageously maintains all current logic and historical data.

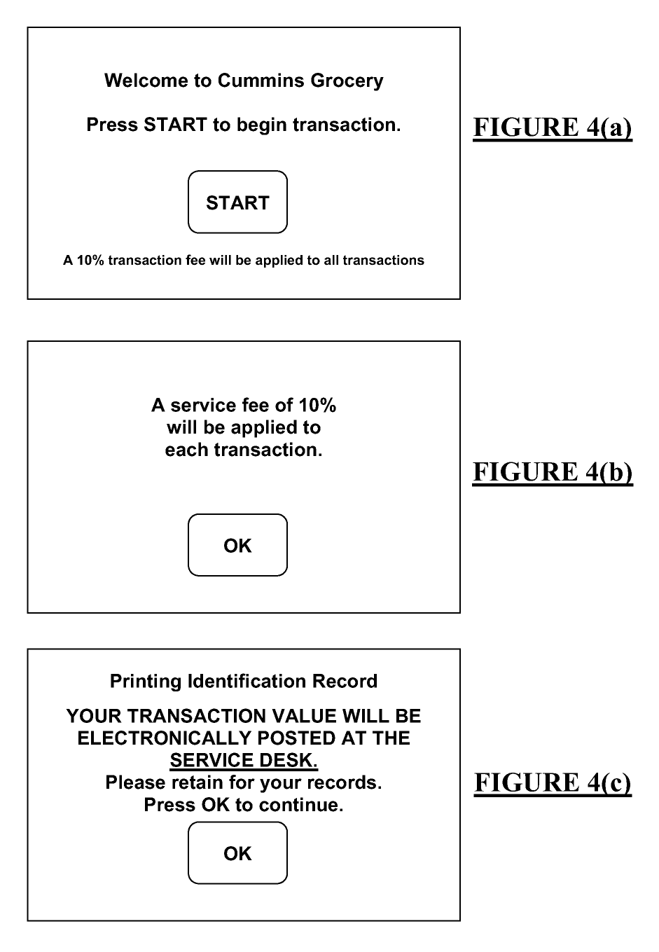

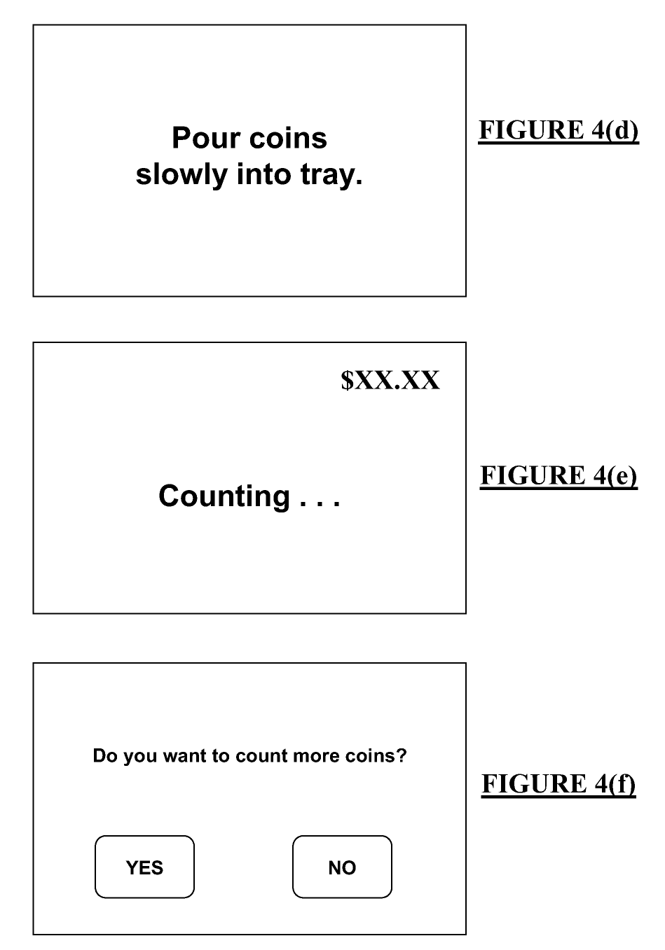

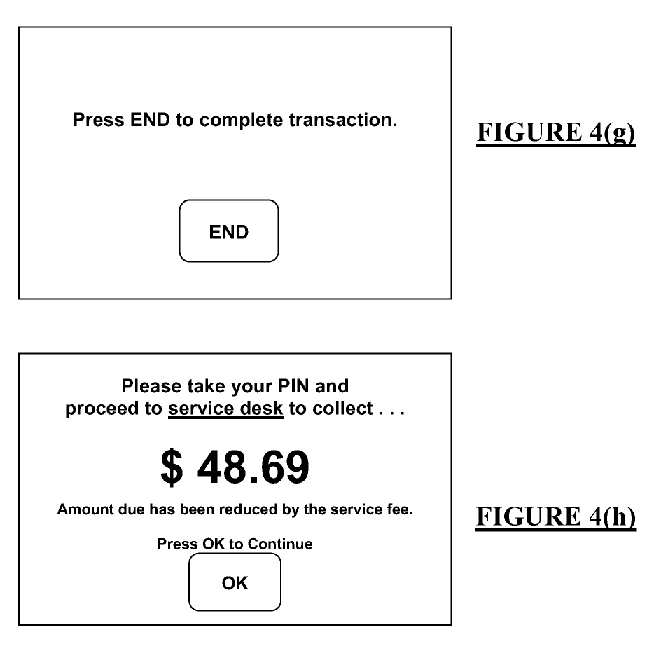

The SSC may utilize any combination of or type of coin receptacle such as, but not limited to, one or more mixed coin bags, one or more single denomination coin bags (sorted bags), a single coin bin (e.g., mixed coins), a plurality of coin bins (e.g., sorted coins), or the like. To illustrate aspects of a method in accord with the present concepts, a user approaches the self service coin machine and presses “START” on the SSC machine default screen (see FIG. 4(a)).

In some aspects, the user may be requested to input a usage fee (e.g., a flat fee, such as $1) or, alternatively, the SSC machine may be set up to request and obtain a service fee from the user corresponding to a percentage of the coins counted. If the service fee option is present and enabled, the user will be prompted to accept the service fee for the transaction by pressing “OK” (see FIG. 4(b)). If the user does not press “OK,” the machine will return to the default screen.

If the SSC machine determines that a user desires to conduct a coin processing transaction, such as by an appropriate input by the customer using an input device (e.g., a touch screen or button), the SSC machine automatically prints on a substrate (e.g., a “user identification record”) a randomly generated number or string (e.g., a “user identification number (PIN)” using a random number generator in the SSC machine software and dispenses the substrate to the user. On the substrate is also optionally printed an EAN 13 barcode symbol (or other barcode standard symbol) which includes one or more of the time, date and PIN #, or other transaction related data. In still other aspects, the SSC machine is configured to dispense a substrate comprising an active or passive RFID (Radio Frequency Identification) tag wherein, in lieu of a randomly generated number or string, the RFID associates the user with the transaction.

The randomly generated number or string may be generated at any time before the coin processing transaction is initiated, during the coin processing transaction, or after completion of the coin processing transaction. The substrate may be printed at any time, subsequent to the generation of the randomly generated number or string, before the coin processing transaction is initiated, during the coin processing transaction, or after completion of the coin processing transaction. As one example, the SSC machine may determine that a user desires to conduct a coin processing transaction user following a user input to a SSC machine touch screen requesting coin processing, at which point the substrate bearing the randomly generated number or string could be dispensed and the SSC machine rendered ready for use to conduct the coin processing transaction. In another example, the SSC machine could be rendered ready for use to conduct the coin processing transaction and the substrate bearing the randomly generated number or string could be printed at a later time, such as during or after the coin processing transaction. The enabling of the SSC machine to conduct the coin processing transaction may be automatic or be responsive to a user input, such as by inputs including, but not limited to, an input by a user via a user-input device (e.g., keyboard, soft key, touch screen, biometric input device, etc.) or by a user's removal of the substrate bearing the randomly generated number or string from the associated SSC machine dispenser.

Although the number or string noted above is characterized as a randomly generated number or string, the number or string may alternatively be selected from a table or may be a pseudo-random number or string. Further, the source of the random number or string may be internal (e.g., the SSC software) or external (e.g., a EPOS terminal, a remote computer) and the random number or string may be generated at any time relative to the transaction. In some aspects, an externally generated random number or string is transmitted to the SSC machine prior to the commencement of a coin processing transaction. For example, the random number or string may be transmitted to the SSC machine at the end of a coin processing transaction for a subsequent coin processing transaction. In other aspects, the randomly generated number or string is transmitted to the SSC machine, or generated therein, during or after a coin processing transaction.

In still other aspects, in lieu of a randomly generated number or string, the PIN may be a number or string selected by a user. Appropriate safeguards may be implemented to prevent the occurrence of duplicate user-entered numbers or strings.

In yet other aspects, in lieu of a randomly generated number or string, the number or string associated with the transaction may be derived from an object inserted by the user into a reading device of the SSC machine or disposed in a position where a reading device of the SSC machine can read information from the object. For example, the user may be instructed to insert a card (e.g., a credit card, a store loyalty card, a bank card, a driver's license, an ATM card, a government-issued ID card, a student ID card, an integrated circuit (IC) card, etc.) into a card reading device before, during, or after a transaction. The SSC machine reads information, such as magnetically stored information on a magnetic strip and associates this information with the transaction. Thus, the last four digits of the credit card number, all digits of the credit card number, a subset of digits of the credit card number, or the verification code for the credit card could be used. Alternatively, the reader could be an optical reader configured to read image data of the card or a portion of the card. In another configuration, the reading device could be a sensor configured to receive a signal from a user-carried object (e.g., a key-fob or near field communication (NFC) device). Following input of transaction identifying information by the user, the SSC machine displays the redemption amount, preferably displays to the user confirmation of the association of the object with the transaction, preferably informs the user that they will need the object to conduct the redemption transaction, and prints and dispenses a non-redeemable receipt. When the user goes to a EPOS to receive the redemption amount, the user associates the previously utilized object (e.g., card, fob, cell phone, etc.) with an associated EPOS reading device to identify the coin processing transaction. The cashier/teller/manager then, upon verification that the associated coin processing transaction is valid (e.g., an “open” number), tenders to the user the amount owing or applies the amount owing to a user-specified transaction (e.g., purchase of merchandise, purchase of stored value card, application of a portion of the amount owing to a store account, etc.), with any remainder being tendered to the user.

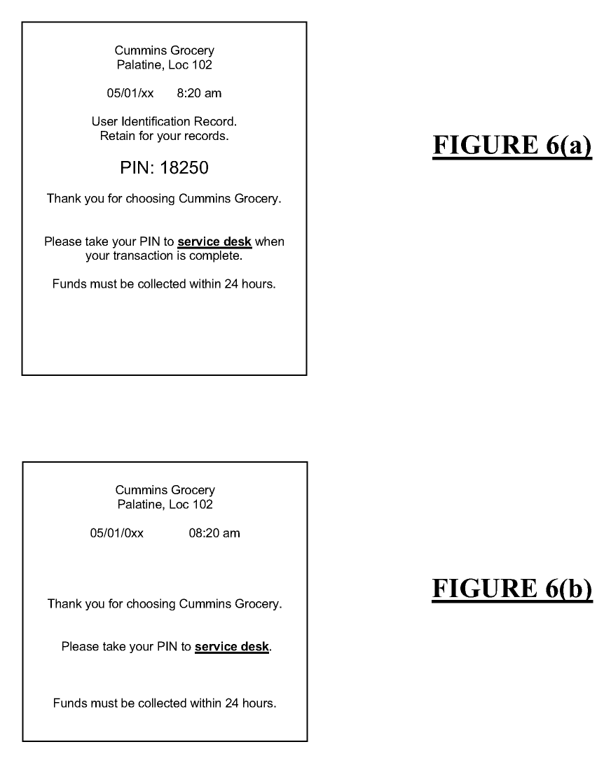

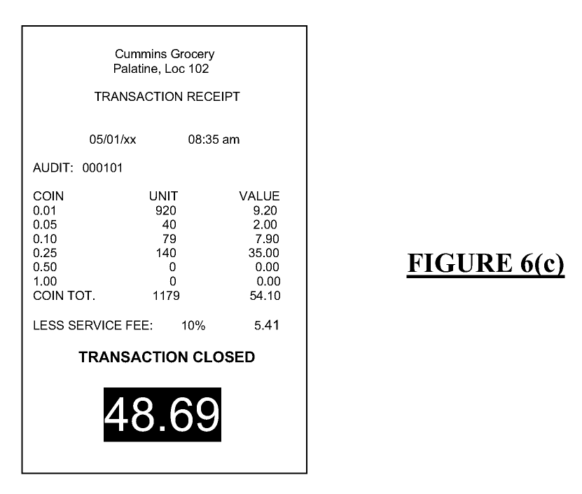

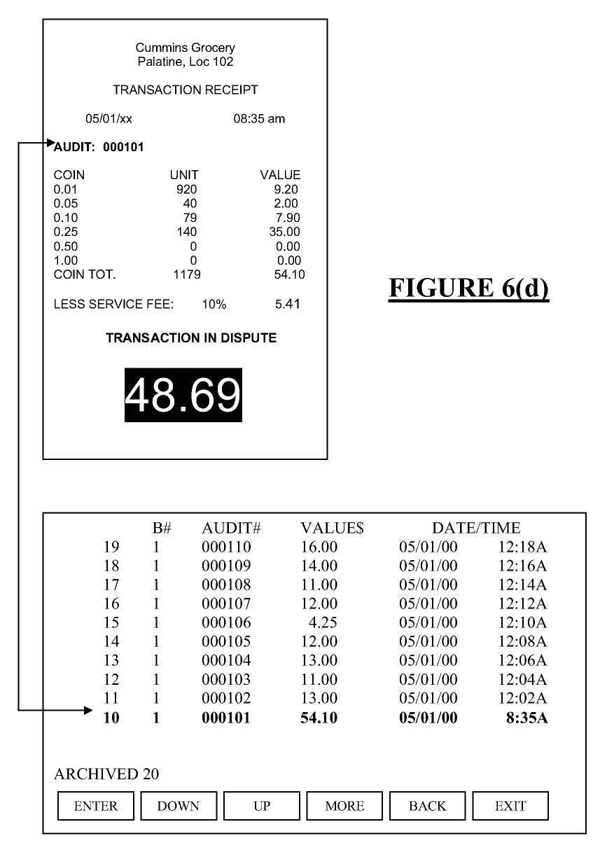

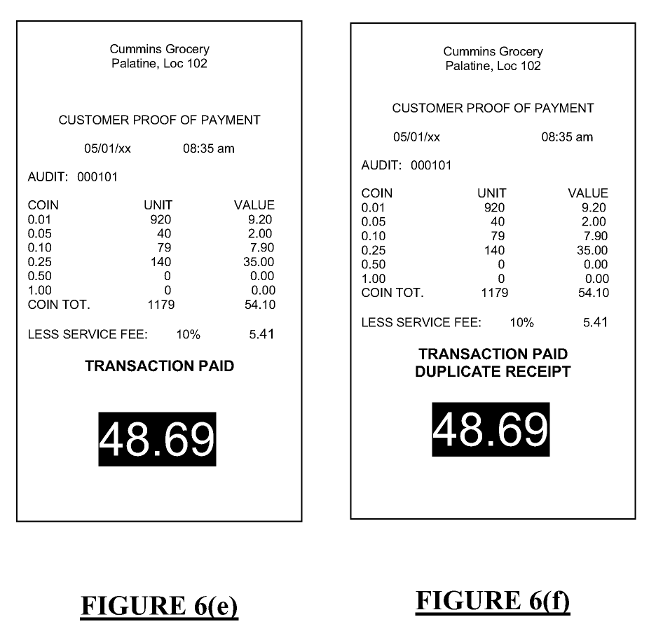

If the substrate is unable to be dispensed, for any reason (e.g., out of paper, out of ink, paper jam, printer malfunction, etc.), the machine may advantageously be prevented from initiating coin counting or from even accepting coins. Following the output of the aforementioned substrate bearing the PIN, such as shown in FIGS. 4(c) and 6(a), the SSC prompts the user, such as via a display prompt and/or audio prompt, to pour their coins into the gravity feed tray, shown in FIG. 4(d). Optionally, the SSC is configured to display to the user a tally or total of the coins that have been processed, such as is shown in FIG. 4(e) (see “$XX.XX”). Alternatively, or concurrent with the display of the tally or total, the SSC may display advertisements or other informational displays. Thus, advertisements may be displayed at the same time that the coin totals are being displayed to the user.

Similarly, the present concepts include the use of remote (or local) systems to perform software updates, wherein new *.exe and *.dll files, or other files, for example, are downloaded into a directory on the self-service terminal computer's hard drive. The SSC machine, if needed, may also be provided with an instruction to reboot at an appropriate time (e.g., 2:00 am).

Returning to the operation of the SSC machine, as is used by way of example to illustrate aspects of the present concepts, shortly after no further coins are detected by the SSC machine sensor, such as at a preset or predetermined delay (which may be selected from any desired delay time), a screen is displayed prompting the user as to whether they desire to process more coins, shown in FIG. 4(f). If the user selects “YES,” the SSC turntable motor will start and return the SSC machine to a condition ready to receive coins. In the user selects “NO,” indicating that the user is finished processing their coins, a screen is displayed prompting the user to complete their transaction, shown in FIG. 4(g), by pressing “END” (or providing another designated user input) or a screen is displayed informing the user (without any user input) that the transaction is complete. For example, a screen is displayed with the amount (in a large font) due to the user and text directing them to proceed to the service desk (or other specified location) to collect their funds, shown in FIG. 4(h). The transaction data is transferred to the memory of the EPOS terminal 54 and flagged therein as an “open” transaction. Optionally, other flags, folders, pointers, or data structures, or more generically, a specified state, may be utilized to indicate open transactions. The user, immediately or at some other time, goes to the cashier/teller window, desk, register, or other specified location to complete the redemption transaction.

In some aspects of the present concepts, the user tells the cashier/teller their PIN and the cashier/teller enters the number into the EPOS system via the EPOS terminal 54 and, if the entered number is determined by the EPOS system to be valid (e.g., an “open” number), the cashier/teller is then authorized to tender to the user the amount owing or apply the amount owing in whole or in part to a user-specified transaction (e.g., purchase of merchandise, purchase of stored value card, application of a portion of the amount owing to a store account, etc.), with any remainder being tendered to the user. By entry of the number, it is meant that the information is input into the EPOS system via an input device such as, but not limited to, an RF reader, an IR reader, a magnetic strip reader, a near field reading device, a keypad, a keyboard, touch keys on a touch screen display, etcetera. In another aspect of the present concepts, the user gives the cashier/teller their substrate bearing the PIN and the cashier/teller enters the number and, if valid (e.g., an “open” number), tenders to the user the amount owing or applies the amount owing to a purchase transaction, with any remainder being tendered to the user. In other aspects of the present concepts, the user inputs their PIN into the EPOS device and, if the PIN is determined to be a valid number, the cashier/teller tenders to the user the amount owing or the amount owing is applied to a purchase transaction, with any remainder being tendered to the user.

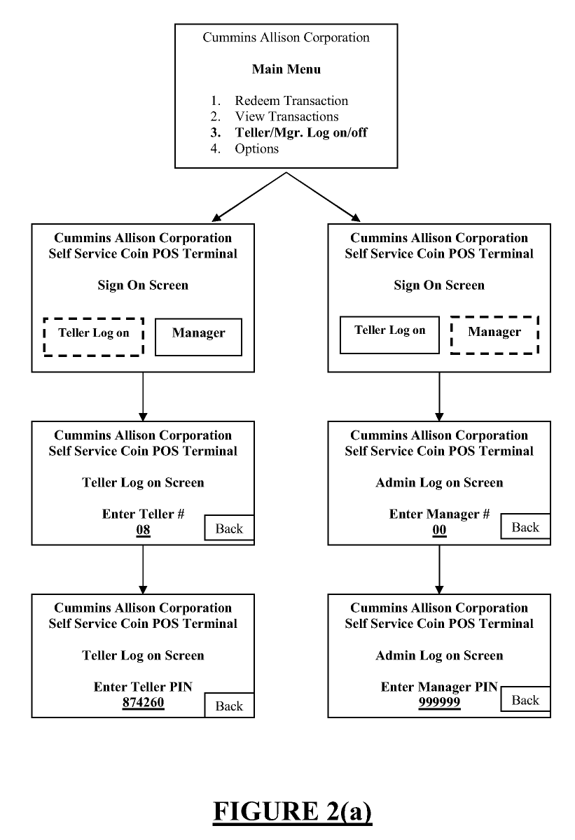

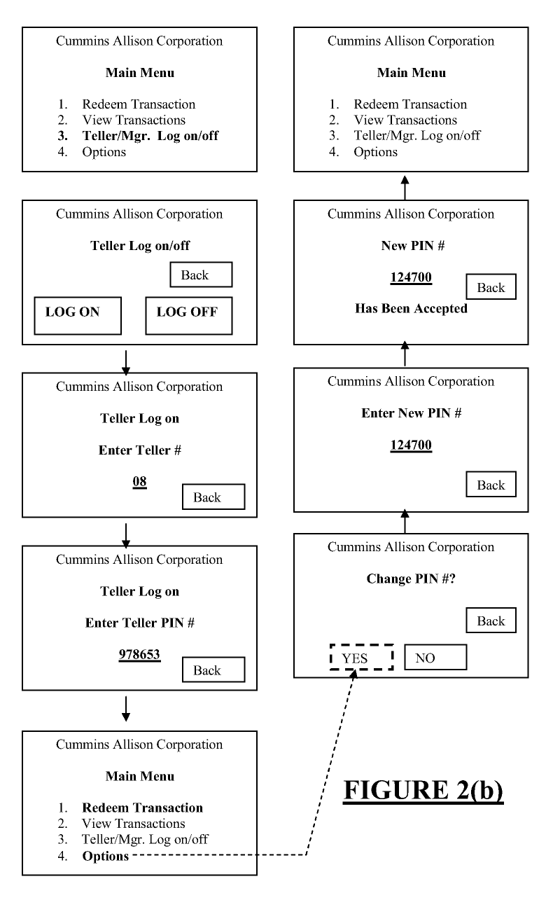

When the EPOS terminal 54 is powered up, it will typically, but not necessarily, display its current software version and date for in an initialization screen, after which after a sign on screen appears or main menu appears including a sign on option. FIG. 2(a) shows a representation of one possible implementation of a main menu including a sign on screen. The main menu of FIG. 1, as presented by way of example, includes options for “1. Redeem Transaction,” “2. View Transactions,” “3. Teller/Mgr. Log On/Off,” and “4. Options”. These options are adaptable to suit any environment or application. For example, “Teller/Mgr. Log On/Off” may instead be “Clerk/Mgr. Log On/Off” or “Cashier/Mgr. Log On/Off”.

FIG. 2(a) further shows an example involving a teller wherein, the leftmost branch of screen representations includes a sign on screen for a “Teller Log On,” followed by a screen representation requiring the teller logging in to enter a “Teller #,” to which the teller in this example enters “08”. The example depicted in FIGS. 2(a)-2(b) could likewise be tailored for other applications, such as for a cashier in a retail store. Following this teller input, the teller is then required to enter the “Teller PIN,” which in the example is “874260”. Similarly the rightmost branch of screen representations includes a sign on screen for a “Administrative Log On,” followed by a screen representation requiring the administrator logging in to enter a “Manager #,” to which the teller in this example enters “00”. Following this manager input, the manager is then required to enter the “Manager PIN,” which in the example is “999999”.

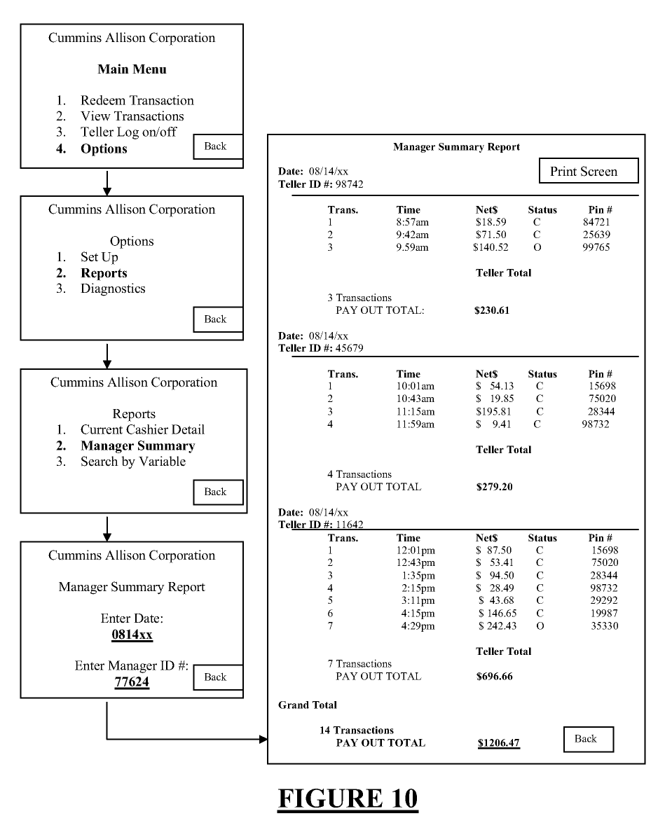

In at least some aspects, the log in screen may precede display of the main menu and the main menu is only shown after a successful log in by a teller, clerk, cashier, manager, or other authorized personnel. In other aspects, the main menu may be displayed, but all options other than the log in screen are rendered non-selectable and the options available to the teller, clerk, cashier, manager, or the like are then rendered selectable according to an access level of the logged on individual. Thus, some options and functions may be selectively enabled for only certain designated individuals. For example, a manager, but not others, may be permitted to add a new “Teller #” and “Teller PIN #” and/or a new “Manager #” and “Manager PIN #.” FIG. 10(d) shows, for example, a manager going into a set up mode wherein the option of “1. Set/Change Password” whereupon, after entering the “Manager #” and “Manager PIN #,” the manager is permitted to then enter a new password. Similarly, following entry of the “Manager #” and “Manager PIN #,” the manager is permitted to “Add Teller” or “Delete Teller” following by a corresponding entry of the “Teller #” and “Teller PIN #” to be added or deleted. To facilitate initial setup, default settings for the “Manager #” and “Manager PIN #” are provided.

FIG. 2(b) shows an example wherein, in the illustrated representative screens, a teller logs on by selection of option “3. Teller/Mgr. Log on/off” from the “Main Menu” and, following selection of a “Teller Log On” option from another screen (not shown) and entry of the teller's “Teller #” and “Teller PIN #”. At the bottom of FIG. 2(b), two options are highlighted. Once logged in, the teller (or cashier or other authorized personnel) is provided access to the “Redeem Transaction” functionality. Another option available to the teller in this example is “4. Options,” which shows one series of screen representations wherein the teller is permitted to change the teller's “Teller PIN #”.

As shown in FIG. 2(b), and various other figures herein, the illustrated example of the “Main Menu” depicts an option for “Redeem Transaction”. This option allows the Teller/Cashier to, in various aspects of the present concepts, redeem transactions, flag disputed transactions, flag closed PIN #'s, flag Invalid PIN #'s and/or flag out of date PIN #'s. In some aspects, some of these functions are not available to the teller/cashier and a manager can authorize (e.g., via a separate code input in an authorization screen that is displayed upon an attempt to execute an unauthorized function) access to selected reports. In certain aspects, information available to the teller/cashier on the EPOS terminal 54 is limited to the specific transactions for which the Teller/Cashier transacted and/or for which the Teller/Cashier was logged in at the time of the transaction. For example, a currently logged on Teller/Cashier cannot see the transaction data of another Teller/Cashier and only the Manager can see all transaction data for all Tellers/Cashiers.

Another option shown in the “Main Menu” is “View Transactions,” which allows a logged in Teller/Cashier or Manager to view various types of transaction data in accord with their access level to such information. In at least some aspects, the “View Transactions” screen data is displayed in chronological or, if desired, reverse-chronological order. A “View Last Transaction,” may also be provided to allow instant recall of only the last transaction data. If the ability to search by specific variables (e.g., date, time, etc.) is required, the Manager may select “Options” and search by PIN, Date, Time, Value and/or Status. As noted above, a “Teller/Mgr. Log on/off,” or separate “Teller Log on/off” and “Mgr. Log on/off” are provided. Alternatively, a “Log On” screen may take the user to a separate screen for designated of access level (Teller or Manager). The Teller Log on/off screen is used, for example, to log off an existing teller after a shift has been completed and log on a new teller at the beginning of a new shift. As a security feature, Tellers and/or Managers may be automatically logged off after a predetermined period of inactivity (e.g., 2 minutes, 5 minutes, 30 minutes, 1 hour, etc.). The EPOS system may be configured to display as “Log On” prompt when not in use or following log off of a teller or Manager.

FIG. 2(b) shows an example wherein a teller logs in, entering into the data input device the teller number “08” and the teller's PIN number “978653,” upon which entry the Main Menu screen is displayed and the teller is able to access all functions or, alternatively, approved options from the Main Menu in accord with the teller's clearance level. For example, the teller may be approved to effect option number one, “Redeem Transaction”. Once the teller is logged in, they can perform other functions by selection the fourth option shown, “Options”. One such option shown in FIG. 2(b) permits the logged in teller to “Change PIN #”. In the illustrated example, the teller changes his or her teller PIN number from “978653” to “124700”.

In at least some aspects, once a person signs in, whether a cashier/teller or a manager, all activities and/or transactions conducted on the EPOS terminal 54 are logged or recorded against the cashier/teller/manager number for the period for which that person is logged in. Various modes may be selected by a manager setting up the EPOS system, such as a permanent sign on (a cashier/teller is signed on indefinitely until they sign off), a temporary sign on (a cashier signs on to perform a payout and is then automatically sign off), or a timed sign on (a cashier/teller is signed on for a user defined duration in minutes such as from 1 minute to 12 hours).

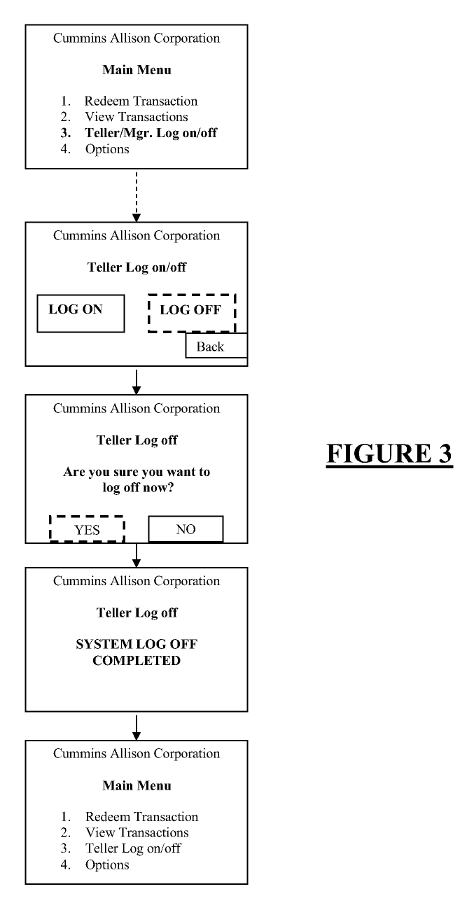

FIG. 3 shows an example wherein, from the Main Menu, “3. Teller/Mgr. Log on/off” is selected, which leads to a Teller Log off screen wherein the teller or manager is allowed to log on by pressing the appropriate key (“LOG ON”) if not yet logged in or is allowed to log off by pressing the appropriate key (“LOG OFF”) if already logged in. Navigation key(s), such as the “Back” key are also advantageously provided. FIG. 3 shows that the teller is logging off, with the dashed lines around the “LOG OFF” key indicating a selection of that key by the teller. This is followed in the illustrated example by a confirmation request screen wherein the teller is asked to confirm that the teller desires to log off. Following the teller's confirmation of the desire to log off, the display screen displays a message confirming that the teller has indeed completed the log off process. Once a teller, manager, or cashier has logged off, the software is advantageously configured to prohibit access to the Main Menu functionality, save for the option “3. Teller/Mgr. Log on/off”. In at least some aspects of the present concepts, the teller, cashier or manager is automatically logged off upon the completion of each redemption transaction, so as to prevent any other the teller, cashier or manager from inadvertently or intentionally using the EPOS terminal 54 under another individual's PIN.

FIGS. 4(a)-4(h) show an example of a redemption transaction. In FIG. 4(a), the display of a self-service coin processing machine provides a “START” key and notes that a 10% transaction fee will be applied to all transactions. Alternatively, other transaction fees may be applied to the transactions and appropriately indicated on the initial display to the customer. In some aspects of the present concepts, the transaction fee may be omitted or waived. In the present example, however, a transaction fee is imposed and, following the customers' selection of the “START” key in FIG. 4(a), the screen of FIG. 4(b) again notifies the customer that “A service fee of 10% will be applied to each transaction” with an “OK” key, and optionally other navigation keys or customer inputs, to ensure that the customer is aware of the service fee.

In FIG. 4(c), the display states that the self-service coin processing machine is “Printing Identification Record” and that “YOUR TRANSACTION VALUE WILL BE ELECTRONICALLY POSTED AT THE SERVICE DESK” and “Please retain for your records.” The display also includes a customer input key (“OK”) and displays a message of “Press OK to continue.” The display may also be configured in a set-up mode to allow the customer to enter the location of where the transaction is to be posted, such as “SERVICE DESK” or “CUSTOMER SERVICE”. The location entered may be accessed through subsequent screens or outputs.

FIG. 4(d) shows an instruction to the customer to “Pour coins slowly into tray” and FIG. 4(e) informs the customer that the self-service coin processing machine is counting the coins. On the display of FIG. 4(e) is preferably shown an accumulated total of the processed coins, represented by the field “$XX.XX,” showing the value of the processed coins as they are being processed and tallied. Once the counting is complete, FIG. 4(f) shows a prompt “Do you want to count more coins?” with customer input keys for “Yes” and “No”. If the customer desires to count another batch of coins, the customer can press the “Yes” key, input the additional batch of coins, and the display represented in FIG. 4(e) is again shown. FIG. 4(g) shows one possible screen that could follow that of FIG. 4(f) following a customer's input of “No” to the prompt of “Do you want to count more coins?”. In FIG. 4(g), the customer is prompted to “Press END to complete transaction” and an “End” key is provided to receive the customer input. Optionally, other navigation keys or customer inputs (e.g., a “Back” button) may be provided.

FIG. 4(h) displays to the customer a message stating “Please take your PIN and proceed to service desk to collect . . . $48.69” and informs the customer that the “Amount due has been reduced by the service fee”. In this example, the coin total value was $54.10 and the transaction fee was $5.41, resulting in a redemption total of $48.69. The customer is then prompted to “Press OK to Continue” or, alternatively, the display of FIG. 4(h) may simply time out after a predetermined period of time.

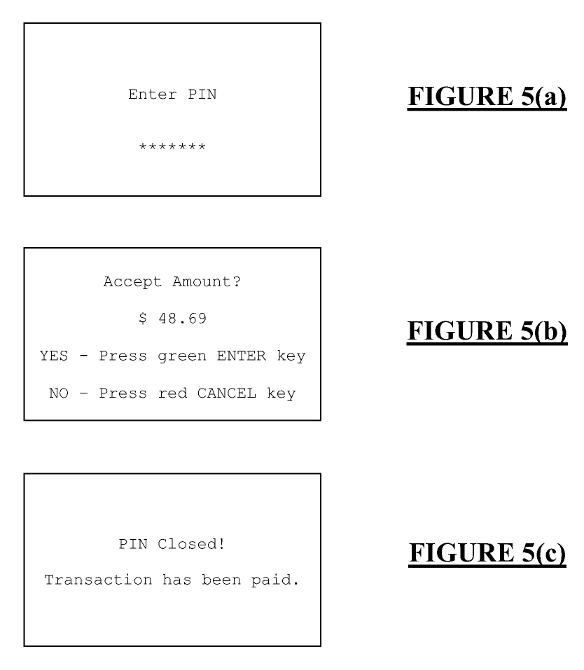

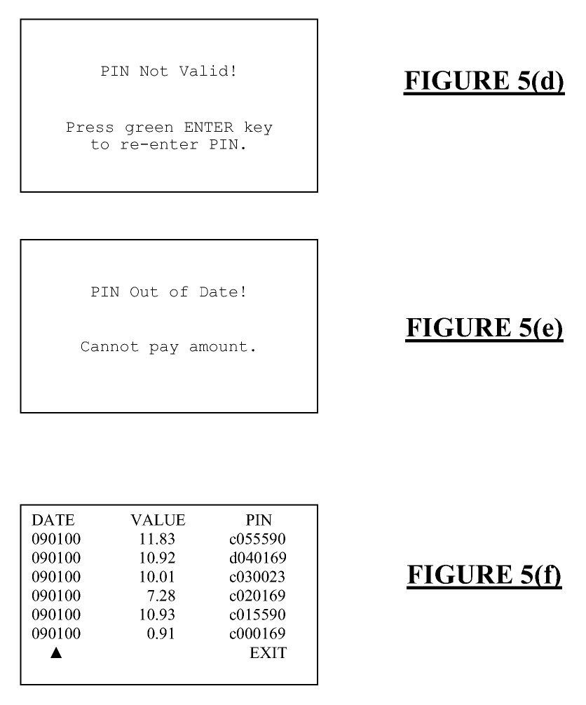

FIGS. 5(a)-5(f) illustrate various exemplary screens that may be displayed on the EPOS terminal 54 is association with a redemption transaction. Following log in, the Cashier/Teller selects “Redeem Transactions” from the Main Menu and is prompted in FIG. 5(a) to enter the user identification number (PIN) from the substrate (see FIG. 6(a)) into the EPOS device at the default screen. In the illustrated aspect, the PIN is displayed as asterisks (*), but may alternatively display the actual input numbers and/or characters. Upon validation of the input PIN (FIG. 5(a)) by the EPOS terminal 54 logic memory, or by an associated (e.g., external) memory and controller, the value due to the user is displayed on the EPOS terminal 54 screen along with the prompt “Accept Amount?,” as is shown by way of example in FIG. 5(b). The cashier or teller is then prompted to press the “Press green ENTER key” if the amount is accepted and to “Press red CANCEL key” is the amount is not accepted.

A valid PIN is one flagged as “open” or “disputed” in the EPOS terminal 54 memory (or in an associated memory and controller). For various reasons, the PIN may not be validated by the EPOS terminal 54 memory. For example, the PIN may have already been closed (FIG. 5(c)), the PIN may not be a valid number (e.g., incorrectly entered) (FIG. 5(d)), or the PIN may be out of date (e.g., not redeemed within predetermined period of “XX” minutes or hours (or days, weeks, months) as noted on SSC display and substrate dispenses thereby (FIG. 6(a)) (FIG. 5(e)). FIG. 5(f) shows a representation of an EPOS display showing a number of transactions. Each transaction comprises a PIN and, preceding each PIN is the illustrated example is a character “c” for “closed” and “d” for “disputed”. Open transactions could likewise be represented by an “o” for open, by an empty field, or by some other identifier. In other alternative screen configurations, the EPOS display may be configured to show fields for “DATE,” “GRAND TOTAL,” “NET,” “STATUS,” and PIN”. The “GRAND TOTAL” would represent to accumulated total of the transaction, whereas “NET” would represent the redemption value. The “STATUS” would likewise designate the transaction as open, closed, or disputed.

If the user agrees with (does not dispute) the total being paid to them by the cashier/teller, the cashier/teller selects “YES” at the “Accept Amount” screen prompt (FIG. 5(b)). A receipt is then printed (e.g., by the EPOS or by an associated printer) for the cashier/teller records with text clearly indicating the “TRANSACTION IS CLOSED” (FIG. 6(c)). The transaction is flagged as “closed” in the EPOS terminal 54 memory and/or associated external memory.

If the users disagrees with (disputes) the total being paid to them by the cashier/teller, the cashier/teller selects “NO” at the “Accept Amount?” screen prompt (FIG. 5(b)) and does not pay the user. A receipt is printed for the cashier/teller records with text indicating the “TRANSACTION IN DISPUTE” (FIG. 6(d)). As is shown in FIG. 6(d), the Audit Number listed on the receipt (“000101” as shown in the example) is correlated to a corresponding Audit Number in the in the EPOS terminal 54 memory or associated memory or database (e.g., an SSC memory, a remote memory) and flagged as being “disputed”. The transaction remains payable and dispute resolution measures are undertaken by the cashier/teller or manager. As one example of a dispute resolution measure, the teller selects “NO” key on EPOS terminal 54 to indicate that the user does not agree with total being paid to them, which causes the generation of a TRANSACTION IN DISPUTE receipt, as noted above, the TRANSACTION IN DISPUTE receipt including the transaction Audit #. The teller/cashier, or the manager, depending on the level of access granted in a particular location, accesses the SSC memory (e.g., through touch screen menus available to the teller/cashier or manager, through a remote terminal, etc.) and goes to “Archive Reports”. The teller/cashier or manager may then scroll down to (or search for) the specific transaction record in dispute is located. The record can be located by Audit #, transaction amount, time, date, etc. The teller/cashier or manager may then request a “Print Archive Batch” report which will provide coin count and transaction total for the specific record (Audit #) in question. The teller/cashier or manager may then review this information with the user and settle the dispute, completing the payout transaction at EPOS terminal, as necessary, and classifying the transaction as closed.

Returning to the normal course, with a transaction that is not in dispute, the EPOS terminal 54 screen changes to “Pay this Amount and Select OK”. The cashier/teller pays cash to the user in the amount displayed on the EPOS terminal 54 screen or, alternately, gives them credit, coupons, or a gift card (e.g., a store stored value card) in an equal or related value. The cashier/teller places their receipt in their cash drawer for balancing with or absent any additional record-keeping requirements. The cashier/teller then presses “OK” to return the EPOS terminal 54 screen back to the default screen. A receipt is printed for the user to keep as proof of payment (FIG. 6(e)). A transaction receipt may be generated by the store EPOS system, in which case a user receipt may not be required. The user receipt is an option that can be either enabled or disabled in set up of the system and may be presented an option to the user to receive or forego the receipt.

Optionally, the system may be configured to permit the printing of a duplicate receipt (e.g., should the printer jam or run out of paper). This may be facilitated by selecting “View Transactions” from the Main Menu and selecting “View Last Transaction.” Entering “View Last Transaction” will bring up the last transaction and must allow the ability to print a duplicate transaction receipt (see FIG. 6(f)). When the last transaction is displayed, the screen may indicate “Print Duplicate Receipt YES-NO”.

It is desirable, in accord with at least some aspects of the present concepts, to have the SSC capture the tally screen (FIG. 4(h)), or the data associated therewith (e.g., amount due) and store it to a local or external (local or remote) memory to permit recreation of this screen at the SSC when this transaction is selected in the historical transaction list. One benefit associated therewith arises in disputed transactions. In the event the store operator must prove to the user that the amount on their EPOS terminal 54 matches the amount on the SSC, recreating the screen will be sufficient proof to the user of the transaction amount.

As noted above, the redemption system disclosed herein may comprise many modes selectively defined on an individual basis and/or on a job title basis. The mode entered (e.g., at the EPOS) is defined by a user identification and password entry. In some respects, these functions may be replaced by a user's biometric input (e.g., a fingerprint of the user as read by a fingerprint scanning device), which serves both as an identifier and as a security measure. In various aspects, Administrators and Manager level individuals can define the access level in Password Maintenance, set up or change a manager or cashier/teller, set up or change a Cashier/Teller or change their own password. Cashiers/Tellers may, in some aspects, be permitted only to change their own password and process redemption transactions.

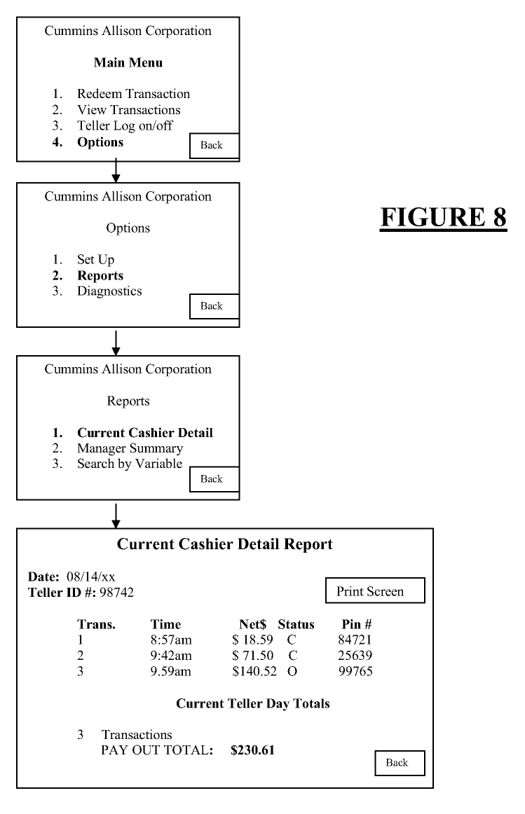

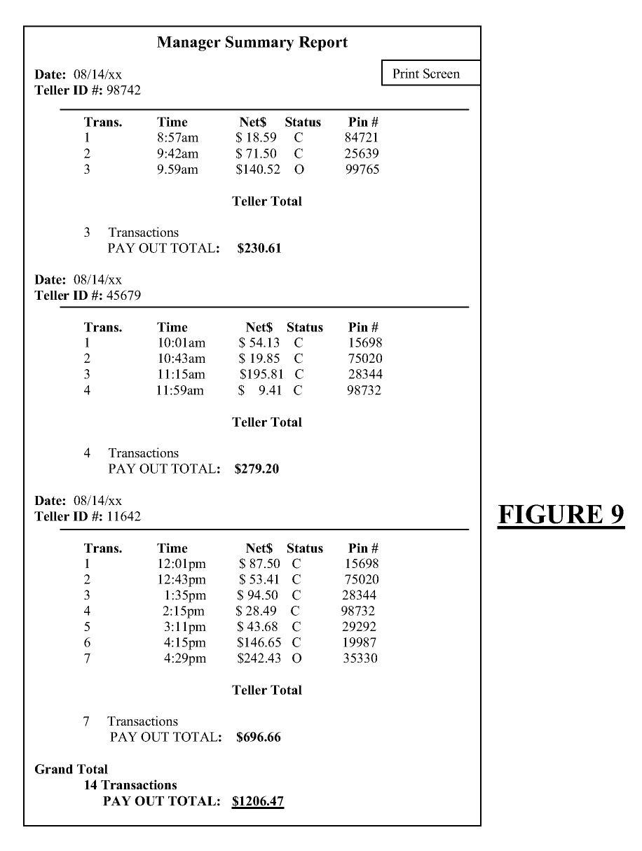

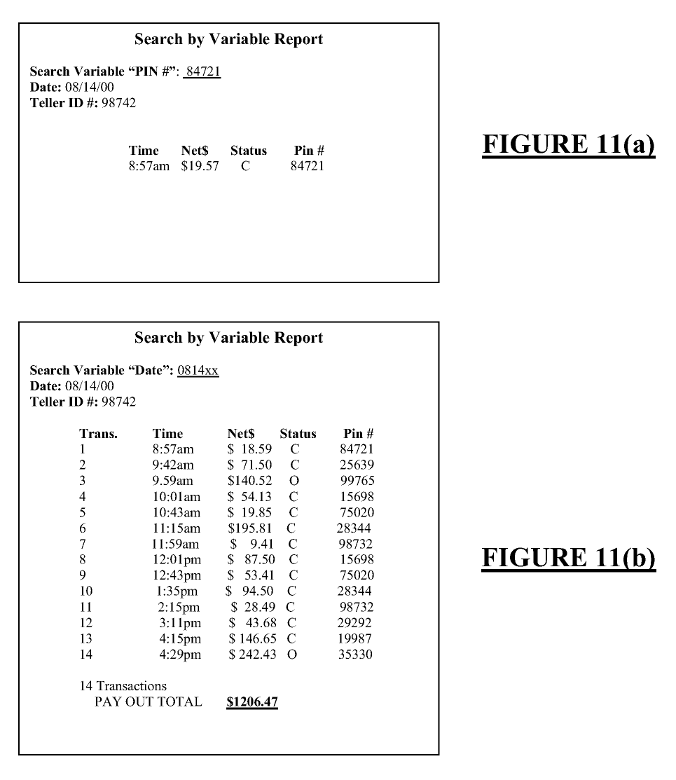

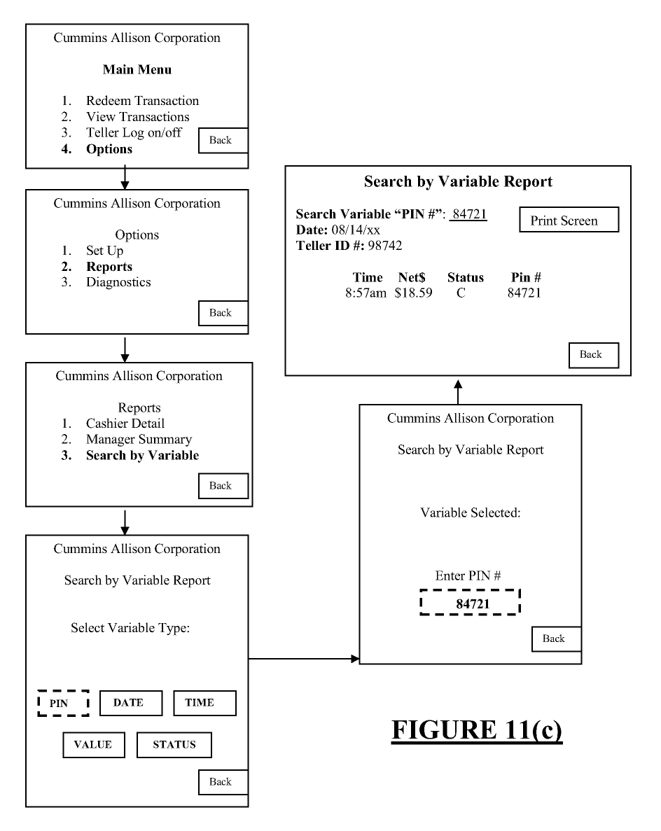

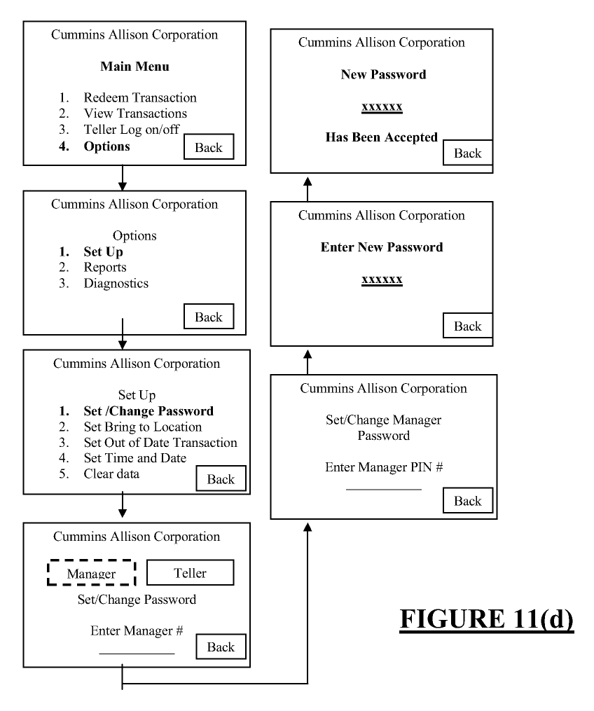

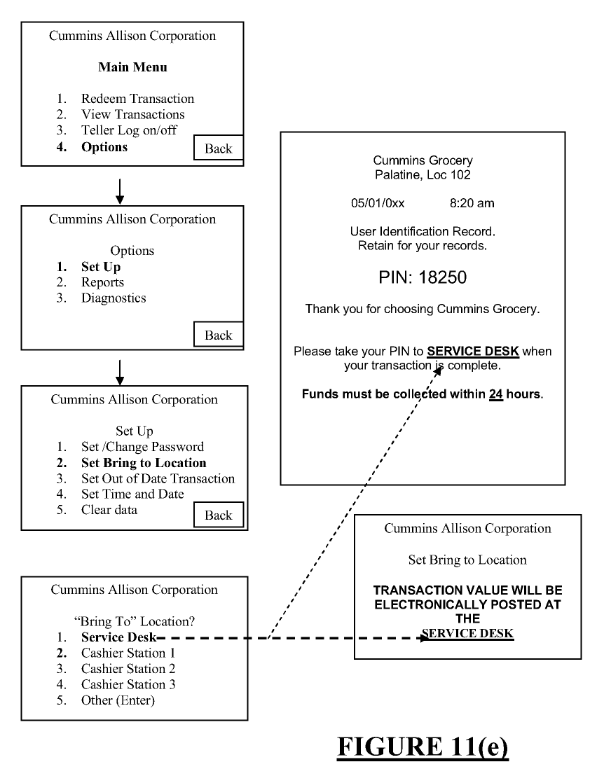

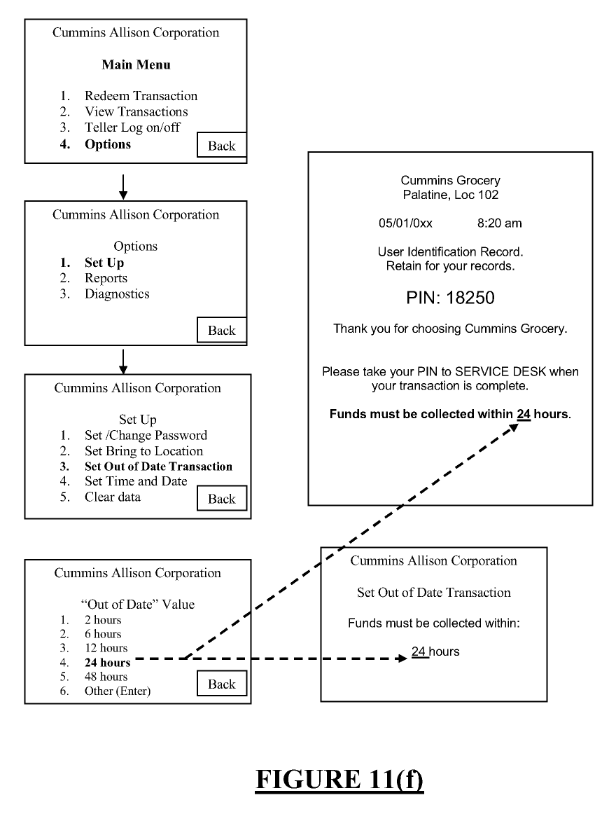

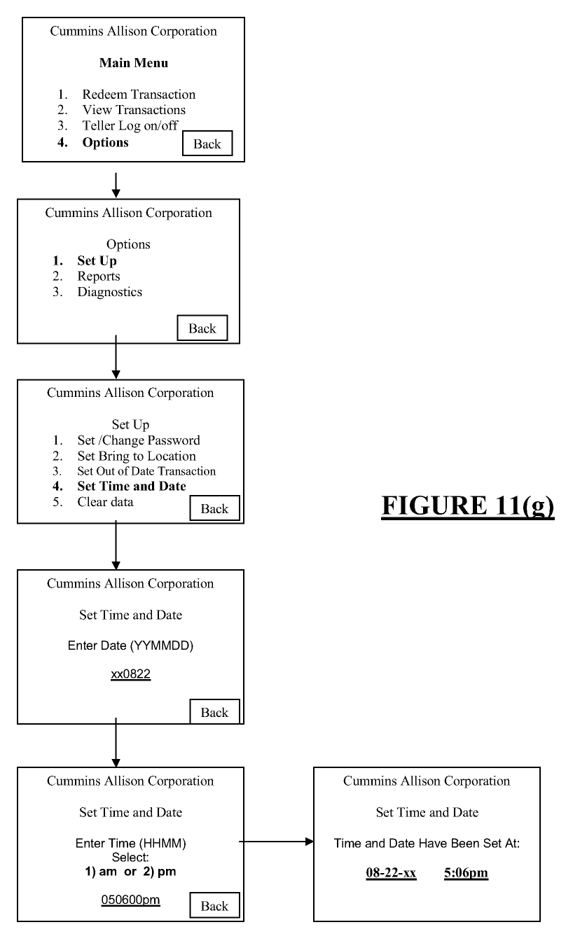

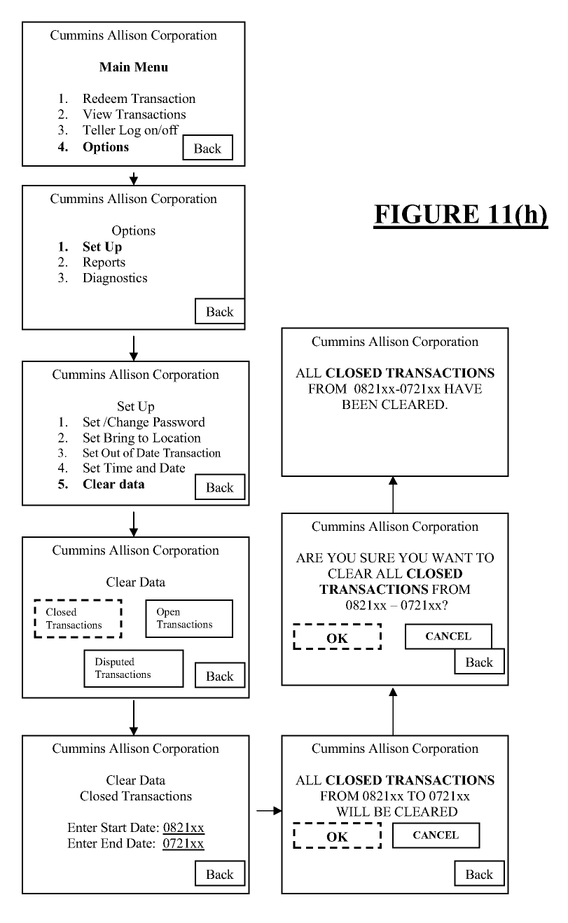

A Cashier/Teller Mode, for example, may include any one or more of viewing and printing “Current Cashier Detail Report” (see FIG. 8), printing cashier transaction receipt, viewing last transaction, printing duplicate receipt, printing user courtesy receipt, and change current cashier/teller password, as described by way of example below. A Manager Mode, for example, my include all functionality in the Cashier/Teller Mode plus any one or more of viewing/printing open transactions, viewing and printing all transactions, access to Options mode including Setup Mode, and Reports and Diagnostics. In the Reports and Diagnostics Mode, the Manager may be given the ability to view and/or print a “Cashier Summary Report” (FIG. 8), a “Manager Summary Report” (FIGS. 9-10), a “Search by Variable Report” (FIGS. 11(a)-11(b)), as described by way of example below.

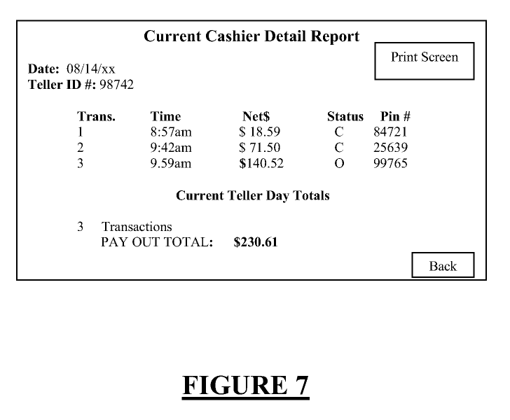

FIG. 7 shows a cashier detail report wherein a logged in teller, cashier or manager is able to retrieve data for the transactions that were redeemed by that teller, cashier or manager. The teller, cashier or manager is thus able to obtain day totals, such as the “PAY OUT TOTAL” and may obtain summary information about, for example, the time of the transaction, the net value of each transaction (i.e., the redemption value dispensed from the till or owing from the till), the status of the transaction (e.g., closed, open, disputed), and the unique PIN associated with each of the identified transactions. Navigations tools, such as a “Back” button are advantageously provided, as are other functional keys or buttons, such as a “Print Screen” button.

FIG. 8 shows a current cashier daily summary report EPOS screen flow. The first screen displays the “Main Menu” with the options of “1. Redeem Transaction,” “2. View Transactions,” “3. Teller Log on/off,” “4. Options”. Option “4. Options” was selected which leads to the “Options” screen, which provides further options for “1. Set Up,” “2. Reports,” and “3. Diagnostics”. In FIG. 8, the option of “2. Reports” was selected which then leads to a “Reports” display. The “Reports” display provides further options for “1. Current Cashier Detail,” “2. Manager Summary,” and “3. Search by Variable”. As shown, the user selected the first option “1. Current Cashier Detail,” which shows in the illustrated example the Current Cashier Detail Report of FIG. 7.

FIG. 9 shows an exemplary Manager Summary Report that shows the Current Cashier Detail report for each of the cashiers for which the manager is responsible, providing a detailed breakdown of transaction data for each of the teller PINs and providing a grand total for the displayed transactions. FIG. 10 shows a manager summary report EPOS screen flow. The first screen displays the “Main Menu” with the options of “1. Redeem Transaction,” “2. View Transactions,” “3. Teller Log on/off,” “4. Options”. Option “4. Options” was selected which leads to the “Options” screen, which provides further options for “1. Set Up,” “2. Reports,” and “3. Diagnostics”. In FIG. 8, the option of “2. Reports” was selected which then leads to a “Reports” display. The “Reports” display provides further options for “1. Current Cashier Detail,” “2. Manager Summary,” and “3. Search by Variable”. As shown, the manager selected the second option “2. Manager Summary,” which shows in the illustrated example the Manager Summary Report of FIG. 9.

As noted, the Manager is permitted in a Setup Mode to set up and maintain password levels for cashier/teller, the ability to set an change “bring to location” for PIN #, the ability to set and change out of date transaction time and the ability to set time and clear data. An administrator mode may include network set up, serial communications set up, password maintenance, diagnostics, viewing and printing error list, and password maintenance of cashier/tellers and managers.

FIGS. 11(d)-11(h) shows aspects of possible “set up” features accessible through, for example, a set up screen including, but not limited to, password setup and maintenance (FIG. 11(d)), “bring to” location (FIG. 11(e)), set “out of date” transaction time (FIG. 11(f)), set time and date (FIG. 11(g)), and clear data (FIG. 11(h)). The EPOS system may also be configured to permit a manager to search for a transaction in the EPOS terminal 54 database by a status identifier (e.g., closed status, open status, disputed status, etc.). The manager would select this option (e.g., “Status Identifier Search”), enter the transaction number, and then select “open” or “closed” or “disputed” from the prompt. The EPOS terminal 54 will either indicate the value of the transaction and its status, or it will return an error message. In other aspects, the EPOS system may be configured to permit a cashier/teller and/or manager to search for a transaction by the amount of the transaction. This would allow, for example, a manager to enter an amount to see all transactions with that amount and their corresponding transaction data, which is useful in resolving disputes.

An example of a potential EPOS Screen Flow for the “Search by Variable Report” shown in FIGS. 11(a)-11(b)) is depicted in FIG. 11(c). FIG. 11(a) shows a “Search by Variable Report” wherein the user, in this case a teller identified by Teller ID number “98742,” input as a search variable the PIN “84721”. The query results in the display of and/or printing of selected transaction data associated in the EPOS memory or associated memory with the search variable PIN “84721,” indicating the time of the transaction (8:57 am), the redemption amount (Net$ of $19.57), the status of the transaction (closed), and the PIN number (84721). FIG. 11(b) shows another example of a variable report wherein the same teller searches using a date variable of “Aug. 14, 2000” which causes the EPOS to display, or print if desired, a list of every transaction associated in the EPOS memory or associated memory with the date variable of “Aug. 14, 2000”. FIG. 11(c) shows one example of a flow process that would lead to the display of FIG. 11(a). The first screen displays the “Main Menu” with the options of “1. Redeem Transaction,” “2. View Transactions,” “3. Teller Log on/off,” “4. Options”. Option “4. Options” was selected which leads to the “Options” screen, which provides further options for “1. Set Up,” “2. Reports,” and “3. Diagnostics”. In FIG. 8, the option of “2. Reports” was selected which then leads to a “Reports” display. The “Reports” display provides further options for “1. Current Cashier Detail,” “2. Manager Summary,” and “3. Search by Variable”. As shown, the manager selected the third option “3. Search by Variable” which, following entry of the variable selected (a PIN) by inputting “84721” through a button panel or touch screen keys, causes the EPOS display or associated display to display in the illustrated example the Search by Variable Report of FIG. 11(a).

FIG. 11(d) shows an example of a password set up process for an EPOS in accord with at least some aspects of the present concepts. The first screen displays the “Main Menu” with the options of “1. Redeem Transaction,” “2. View Transactions,” “3. Teller Log on/off,” “4. Options”. Option “4. Options” was selected which leads to the “Options” screen, which provides further options for “1. Set Up,” “2. Reports,” and “3. Diagnostics”. In FIG. 11(d), the option of “1. Set Up” was selected which then leads to a “Set Up” display comprising further options for “1. Set/Change Password,” “2. Set Bring to Location,” “3. Set Out of Date Transaction,” “4. Set Time and Date,” and “5. Clear data”. As shown, the manager selected to set/change the manager password and, following entry of the manager's PIN, the manager is permitted to enter a new password or change an existing password.

FIG. 11(e) shows an example of a “Set Bring To Location” process for an EPOS in accord with at least some aspects of the present concepts. The first screen displays the “Main Menu” with the options of “1. Redeem Transaction,” “2. View Transactions,” “3. Teller Log on/off,” “4. Options”. Option “4. Options” was selected which leads to the “Options” screen, which provides further options for “1. Set Up,” “2. Reports,” and “3. Diagnostics”. In FIG. 11(e), the option of “1. Set Up” was selected which then leads to a “Set Up” display comprising further options for “1. Set/Change Password,” “2. Set Bring to Location,” “3. Set Out of Date Transaction,” “4. Set Time and Date,” and “5. Clear data”. As shown, the user (not identified in FIG. 11(e)), selected to the option for “2. Set Bring to Location,” which caused the display of another screen presenting options for setting the “Bring To” location comprising “1. Service Desk,” “2. Cashier Station 1,” “3. Cashier Station 2,” “4. Cashier Station 3,” and “5. Other (Enter)”. Once set, FIG. 11(e) shows that the EPOS display will indicate to the user that “TRANSACTION VALUE WILL BE ELECTRONICALLY POSTED AT THE Service Desk.” Likewise, FIG. 11(e) shows that a User Identification Record printed for the user to retain for their records includes the PIN “18250” and an instruction to “Please take your PIN to Service Desk when your transaction is complete” in accord with the above-noted setting of the “bring to” location. Also indicated on the User Identification Record is a statement that “Funds must be collected within 24 hours” in accord with a time-based redemption limitation setting, discussed below.

FIG. 11(f) shows an example of a “Set Out of Date Transaction” process for an EPOS in accord with at least some aspects of the present concepts. The first screen displays the “Main Menu” with the options of “1. Redeem Transaction,” “2. View Transactions,” “3. Teller Log on/off,” “4. Options”. Option “4. Options” was selected which leads to the “Options” screen, which provides further options for “1. Set Up,” “2. Reports,” and “3. Diagnostics”. In FIG. 11(f), the option of “1. Set Up” was selected which then leads to a “Set Up” display comprising further options for “1. Set/Change Password,” “2. Set Bring to Location,” “3. Set Out of Date Transaction,” “4. Set Time and Date,” and “5. Clear data”. As shown, the user (not identified in FIG. 11(f)), selected to the option for “3. Set Out of Date Transaction,” which caused the display of another screen presenting options for setting the “Out of Date” value. The subsequent screen shows options for “1. 2 hours,” “2. 6 hours,” “3. 12 hours,” “4. 24 hours,” “5. 48 hours,” and “6. Other (Enter).” As shown in FIG. 11(f), the user selected “4. 24 hours,” and a corresponding display on the EPOS display confirming the user's selection and noting that, in accord with the selected option of “Set Out of Date Transaction,” the “Funds must be collected within: 24 hours”. Likewise, FIG. 11(f) shows that a User Identification Record printed for the user to retain for their records includes the PIN “18250” and an instruction to “Please take your PIN to Service Desk when your transaction is complete” in accord with the above-noted setting of the “bring to” location. Also indicated on the User Identification Record is a statement that “Funds must be collected within 24 hours” in accord with a time-based redemption limitation setting discussed above.

FIG. 11(g) shows an example of a “Set Time and Date” operation for an EPOS in accord with at least some aspects of the present concepts. Further to the above-noted initial “Main Menu” options, the “Options” screen permits a user to select “4. Set Time and Date” and enter the appropriate time and date.

FIG. 11(h) shows an example of a “Clear Data” operation for an EPOS in accord with at least some aspects of the present concepts. As noted above, for this example, the first screen displays the “Main Menu” with the options of “1. Redeem Transaction,” “2. View Transactions,” “3. Teller Log on/off,” “4. Options”. Option “4. Options” was selected which leads to the “Options” screen, which provides further options for “1. Set Up,” “2. Reports,” and “3. Diagnostics”. In FIG. 11(h), the option of “1. Set Up” was selected which then leads to a “Set Up” display comprising further options for “1. Set/Change Password,” “2. Set Bring to Location,” “3. Set Out of Date Transaction,” “4. Set Time and Date,” and “5. Clear data”. As shown, the user (not identified in FIG. 11(h)), selected to the option for “5. Clear data,” which caused the display of another screen presenting options for clearing the data for “Closed Transactions,” “Open Transactions,” or “Disputed Transactions.” As shown in FIG. 11(h), the user selected to clear data for closed transactions and a corresponding screen is displayed notifying the user that the user is about to “Clear Data—Closed Transactions” and the user is permitted to specify parameters for the operation, which comprises the entry of a start date and an end date for the operation. Alternatively, options may further include, but are not limited to, start and end times, specified shifts, transactions closed by tellers associated with specified teller PIN or manager PIN, or the like. FIG. 11(h) further shows subsequent confirmation screens notifying the user that all closed transactions from the first input date to the second input date will be cleared and requesting a confirmatory input from the user using an appropriate button or touch key. As shown, a redundant confirmation screen is provided followed by a confirmation screen confirming that the clear data operation was performed.

Conventional diagnostic features may also be utilized to permit diagnosis of communication, software, firmware, and/or hardware issues.

Although the previous concepts were generally described in relation to a randomly generated number or string, other alternatives are also considered to fall within the present concepts. The “random number” associated with the substrate and transaction may alternatively comprise a user-entered number, string (e.g., characters, characters and numbers, etc.), or data (e.g., biometric input, fob input, magnetic strip card input, IC card input, RF tag input, etc.). This user-entered number, string or data may be entered by the user prior to input of coins into the SSC machine or following input of coins into the SSC machine, but prior to any processing of the coins. Alternatively, the user-entered number, string or data may be entered by the user following input of coins into the SSC machine or following completion of processing of the input of coins by the SSC machine. As noted above, the “random number” associated with the substrate and transaction may be generated by a SSC machine random number generator, an EPOS device random number generator, or an external device random number generator, or any combination thereof.

The user courtesy receipt shown in FIG. 6(e) may be automatically printed by the EPOS device and dispensed to the user following reimbursement or the EPOS device may optionally prompt the user to determine whether or not they desire a courtesy receipt.

In at least some embodiments, the SSC machine transfers all transaction details to the EPOS terminal 54 upon completion of the transaction on a transaction-by-transaction basis and all transaction data pertaining to open and closed transactions are stored on the EPOS terminal, in the SSC machine itself, and/or in a local or remote external memory.

Although it is possible that transmissions between the SSC machine and the EPOS device may be encrypted, such security measures are not required and are entirely optional.

The present concepts may be implemented in any combination or sub-combination and are not limited to the depicted or described combinations.

The communication between the SSC machine and the EPOS device or any POS device or associated network may, as noted, comprise a wireless connection or a hard-wired connection. Any suitable communication system may be employed and may comprise, but is not limited to, a spread spectrum RF protocol (e.g., BlueTooth), IR, or near field communication (NFC). In one embodiment, the system comprises, a Vx570 VeriFone (Programmed), two BlueTooth Communication Devices, and a JetCoin (SFB, MB, DB) machine. This embodiment requires no change to existing coin processing machines. Following the completion of coin processing, the JetCoin machine sends the transaction information to EPOS via wireless BlueTooth antennas in real time. Alternatively, the JetCoin machine may send data on each processed coin, in real time, to EPOS or external processing device via wireless BlueTooth antennas, with the processing function (e.g., adding of coin totals, determination of fee, etc.) to be handled externally.

As noted, the user may input his or her own number (e.g., a birthday in DDMMYY or YYMMDD format) or string (e.g., “JOHN05” or “JOHNNY”). This obviates the need to print anything from the SSC machine. To instill user confidence, additional screens may be provided at the SSC machine to permit the user to positively view the association of the input number or string to the transaction redemption amount. Keypad shields, display privacy coatings, and other physical measures may be implemented to mitigate the potential for third parties to observe the input by a user and improperly seek to effect redemption of the user's funds.

In connection with the above concepts, or separately therefrom, remote management tools are additional concepts disclosed herein and discussed below. In lieu of a fully networked computer system involving local and remote computers, it is envisaged that one suitable method of conducting day end remote management involves facsimile reporting. In accord with this concept, each SSC (self service coin) machine (or each EPOS) would be configured to automatically dial a designated number at the end of each day, at a designated time, or within a designated range of times, with a transaction status report. Alternatively, in lieu of a purely time-based reporting, the SSC machines could be configured to send the fax in response to a condition. For example, the condition could comprise a bag full (or almost full) signal, so that the fax permits sufficient time for processing to enable scheduling of a call for pickup. In another example, the condition could be a machine or component failure or inoperable status, whereupon a fax is sent immediately.

Responsive to a predetermined condition (e.g., a time-based condition, a machine status condition, etc.), the SSC machine will automatically generate a fax which would be faxed over a telephone line to a pre-programmed number for a central location fax machine. The fax would summarize whatever is relevant to the condition that prompted the fax. For a fax responsive to a time-based condition, the fax would include data that the owner or manager of the SSC machine would like to track and may include, but is not limited to, volume of business for the day (e.g., a gross amount and the net fee), a total commission amount, status of the bag or bins and how close they are to full, volume of business week to date and month to date, a report of any machine failure or machine operating on the margin of acceptable range, and/or notice if a pickup is required in the next day because the bag or bins are close to full (e.g., 80%) or whatever percentage-full amount that is designated. In a centralized system comprising numerous self service coin machines, each machine may be separately programmed or set to send the fax at a specified time or within a range of times (e.g., redialing as necessary until the fax is completed). Alternatively, the central location may transmit to each SSC machine a “ready” signal indicating that it is ready to receive the fax, upon which signal, the SSC machine sends the fax. The information, once received by the central location, would be compiled be a central operations clerk and keyed into the reporting system. Alternately, an automated method at the central location might capture the data via other methods, such as the scanning of the facsimile or OCR, to update the central database.

In an alternative to the above-described fax-based reporting system, a voice phone in-system is also contemplated. In this reporting method, akin to the fax-based reporting system, the SSC machines are programmed to automatically telephone a voicemail system responsive to a pre-determined condition(s). The reports sent by the SSC machines are audible and are similar to the audible systems used by the airlines and other industries, where certain fundamental commands can be shared and received. Under one approach, employees at a central location would play back the voicemails and enter the data. Alternately, at the central location certain audible commands or communications from the remote machines might be able to be received at a central location and electronically understood through software that could understand voice commands. This data would then be collected and compiled and entered into a central database after the audible commands had been interpreted.

Still further, the voicemails output by the SSC machine may be converted into emails at the central location and sent to a designated email account.

In still other embodiments of the fax-based reporting system and/or voicemail-based reporting system, a plurality of facsimile numbers or telephone numbers may be provided to the SSC machine, each of the facsimile numbers or telephone numbers corresponding to a specific report or specific condition. This would clarify the information received in the central location and would perform an initial sorting of the reporting data.

In combination with the above fax-based reporting system and/or voicemail-based reporting system, a substrate stating the conditions of the transaction (e.g., fee, date, time, etc.) may be offered to the customer when they place their coins into the machine or prior to placement of their coins in the machine and/or a receipt provided following processing.

The SSC machine may be configured to display, when not in use, various predetermined advertisements or other information or graphics desired to be displayed (e.g., information about store hours, information directed to customers of a store, sales-related information, promotions, special notices, public service announcements, etc.), such as in fixed graphics form or in video form. The predetermined advertisements or other information or graphics may be downloaded, such as a *.mpg or *.gif video file, or other image or multi-media format, to all SSC machines in a network simultaneously or substantially simultaneously. This permits rapid updating of advertisement content and simple management of content across plural SSC machines. Thus, whereas conventionally advertisement content on self-service kiosks is locally controlled, this aspect of the present concepts permits remote management of video and still advertising on the display(s) of the SSC machine. In one aspect, a separate display (a top box display) may be provided and dedicated to an advertisement function. In association with the remote management of advertisements, the remote management system computer(s) download files to a directory on the SSC machine memory (e.g., a computer hard drive).

Advertisements, such as noted above, may also be coupled with the display of the total amount of the redemption transaction. In other words, the display shown in FIG. 4(h) may be adapted to include, or may be followed by, one or more advertisements or one or more links to advertisements or advertisers. This advertisements or links may be optionally related to the user information, such as may be obtained through a biometric input for a registered user or through a user's loyalty card linked to user personal data, to more specifically target the advertisements and/or links to the particular user's demographic.

Advertisement placements may be for a predetermined period, in the conventional advertisement paradigm or may constitute an on-line bid for placement auction system (see, e.g., Google AdWords) wherein advertisers having advertising content (e.g., video, text, Flash and/or image ads) compete against one another in an open-bid or closed-bid auction (e.g., a CPC (cost per click) and/or CPM (cost per mille) basis) for placement on one or more SSC sites. Thus, a company may pay a slightly reduced amount for the ad placement and agree to pay additional amounts for each “hit” that the ad produces, the “hit” comprising, for example, a user's entry of user personal data (e.g., filling out a contest data sheet with contact information, entering a loyalty card number, etc.), clicking on an input requesting additional information (e.g., a request to print information on the displayed product or company from the SSC), or a user's interaction with the advertisement (e.g., a wireless download of information to the user's personal electronic device, such as a cell phone). For example, an advertiser may pay a fixed rate for placement on a machine (e.g., $5/day) or may pay a lesser rate (e.g., $3/day) in combination with an agreement to pay $0.50 for every “hit”. The placement of ads may also be contingent upon the user of the machine. Certain ads may be held by the SSC machine for selective display to only certain targeted demographics to enhance the potential for a conversion to a sale of that product directly (e.g., in embodiments where the coin processing machine serves a dual function as an internet kiosk).

The placement of an ad may constitute, in some respects, placement on the screen of the SSC in a given location, placement on a particular part of the screen, and/or placement on a particular screen (e.g., an ad on the screen wherein the coin count is being tallied may very well be perceived to be a more valued placement than an ad placed on the initial coin instructional screen to “insert coins” and an ad on the screen displaying to total amount may be perceived to have an even greater value). Exclusivity may also command a price/fee premium in that the advertiser does not have to share the screen with one or more other, and possibly competing advertisers. Additional fee and/or usage based models for advertising fees to be charged to advertisers include a usage model wherein each time an advertisement is displayed, which would typically but not necessarily relate to the usage of the machine, the advertiser is charged a fixed amount. This amount may vary, for example, according to the length of the advertisement and/or the particular screen on which the advertisement is displayed (a variable rate depending on the screen). Thus, an advertisement placed on an “attract” screen that is typically viewed by a large number of persons in passing may have a cost per display that is different than (e.g., lower than) an advertisement associated with the “counting” screen wherein the user's attention upon the screen is often rapt.

The SSC machine may further be configured to, upon entry of customer-specific data (e.g., input of a loyalty card number, credit/debit card number, registered card number, biometric input, or the like), display or deliver ads relevant to that specific customer. For example, the age and sex of the customer provide useful demographic information from which the displayed ads may be tailored. As another example, the products that the customer buys in the store over time may be analyzed to determine whether or not some advertisements would be a better match than other advertisements.

Still further, customers may be provided the option, at the beginning of the transaction, to forego the transaction fee (e.g., 5-10% of the value of the processed coins) by voluntarily watching one or more advertisements by sponsors, who would then be collectively (or individually) assessed the transaction fee or respective proportion thereof. Customers of the SSC system may also be permitted to select from amongst one or more categories of products. Suppose, for example, that a customer doesn't want to be subjected to a “personal products” ad, but might be more interested in see car ads. In the screen selection wherein the customer opts to view one or more advertisements to waive the associated coin processing fees (for the customer at least), the customer may further select from a list the general type of advertisements he or she would like. In accord with this option, the customer may optionally be required to input his or her name, address, and/or valid email account address.

Fee-based advertisements on the SSC machine may include any combination of the above approaches. For example, in one blended approach, a company may pay a slightly reduced amount for the ad placement and agrees to pay additional amounts for each “hit” that the ad produces. The “hit” may comprise, for example, a user's entry of user personal data (e.g., filling out a contest data sheet with contact information, entering a loyalty card number, etc.), clicking on an input requesting additional information (e.g., a request to print information on the displayed product or company from the SSC), or a user's interaction with the advertisement (e.g., a wireless download of information to the user's personal electronic device, such as a cell phone). Thus, for example, an advertiser may pay a fixed rate for placement on a machine (e.g., $5/day) or may pay a lesser rate (e.g., $3/day) in combination with an agreement to pay $0.50 for every “hit”.

The placement of ads may also be contingent upon the user's demographics. Certain ads may be held by the SSC machine for selective display to only certain targeted demographics to enhance the potential for a conversion to a sale of that product directly (e.g., in embodiments where the coin processing machine serves a dual function as an internet kiosk). The SSC machine may further be configured to, upon entry of customer-specific data (e.g., input of a loyalty card number, credit/debit card number, registered card number, biometric input, or the like), display or deliver ads relevant to that specific customer. For example, the age and sex of the customer provide useful demographic information from which the displayed ads may be tailored. As another example, the products that the customer buys in the store over time may be analyzed to determine whether or not some advertisements would be a better match than other advertisements.

In additional variants on the SSC machine advertisement function, the advertisements and/or links may be particularly tied to the amount of the redemption transaction. Thus, at the end of the transaction, the user may be shown items offered by various advertisers that may be purchased using, in whole or in part, the funds from the redemption transaction. To illustrate, John, a 25-year old male uses a SSC machine in accord with some aspects of the present concepts. At the end of the coin processing transaction, John is provided not only the option of simply redeeming the amount owed (e.g., the $48.69 shown in FIG. 4(h)), but is also provided the opportunity to (1) select from a list of pre-selected items having a value less than $48.69 with the value of each selected item being deducted from the redemption value, (2) to browse from amongst a catalogue of items associated with fee-based or pre-paid advertisers and stored in the SSC memory, or (3) to access any one of a plurality of selected on-line stores linked to the SSC machine to directly purchase one or more items from one or more web-sites. Where shipping charges are assessed, the displayed items may automatically factor in the shipping charges or estimated shipping charges so that the user does not have to input additional funds. Alternatively, in some instances, if the redemption amount is large enough (e.g., over $75 or over $100) a number of companies will waive shipping charges. Further, particularly where the customers are interacting with any one of the plurality of selected on-line stores, the customer may be offered incentives from that advertiser, separate and apart from any arrangements that the advertiser has with the owner or operator of the SSC machine, to consummate the sale at that store and not to lose the sale to another company. One such incentive might be to absorb the shipping costs to obtain the sale (and the customer data such as name, address, sex, etc.).

Advertising fees associated with the use of the SSC screen to access on-line stores may also comprise charges for each access by the user to a sponsored link, whether or not any items are actually purchased. The owner of the SSC machine (or third party managing the operation of the SSC and obtaining revenues therefrom) may charge any combination of fees to advertisers including, but not limited to, a maintenance fee to advertisers to maintain their catalogues or catalogue items on the SSC machine, a usage fee per click on a sponsored advertiser's link, and/or a conversion fee for a click on a sponsored advertiser's link that leads to a sale (which may be, for example, a fixed amount or based, an amount that is a percentage of the amount of the sale, or may be the redemption service charge itself, or a percentage thereof that may or may not correspond to a percentage of the processed coins that are applied to the sale/conversion). Returning to the example of John, he may decide that he wants to order a gift basket from Harry and David and send it to his mom. The advertiser, Harry and David, obtains not only the sale, but also two addresses for its mailing lists. This type of advertising exposure and marketing is an untapped resource and promises to benefit not only the owner/operator of the SSC machine, but also the advertiser(s), and users.

Receipts corresponding to the user's on-line purchases or merchandise orders are then printed out with corresponding product information, shipping information, confirmation number, and telephone number to call in case of questions. Any residual value of the redemption total is then, as disclosed herein, transmitted wireless or through a hardwired connection, to the EPOS terminal 54 and redemption of the residual value conducted as described above.

The foregoing disclosure has been presented for purposes of illustration and description. The foregoing description is not intended to limit the present concepts to the forms, features, configurations, modules, or applications described herein by way of example. Other non-enumerated configurations, combinations, and/or sub-combinations of such forms, features, configurations, modules, and/or applications are considered to lie within the scope of the disclosed concepts. For example, the self-service coin processing machine may comprise a first data input data input device configured to receive user identification information (e.g., a number and/or character string input into a key pad or touch screen keys, a fob input, a card input, etc.). In some aspects, a kiosk 500 (see FIG. 1) is associated with the EPOS terminal 54. The EPOS terminal 54 comprises a second data input data device configured to receive user identification information and is configured to cause the kiosk to dispense directly to the user (or alternatively to an intermediary such as a cashier), currency in an amount corresponding to the redemption value when the user identification information input into the EPOS terminal second data input device is determined by the controller of the EPOS system to correspond to an open transaction. In still other aspects, in combination with any of the disclosed examples or combinations of the disclosed concepts, the SSC machine and/or the EPOS terminal 54 or kiosk 500 is configured to provide the user with a non-redeemable transaction record for the user's records, either automatically or upon request. The transaction record may include, for example, the information shown in FIG. 6(e), but is not limited thereto, and may include any information associated with the transaction.

What is claimed:

1. A method of redeeming coins using a self-service coin redemption machine, the method comprising:
printing on a blank substrate, using a self-service coin redemption machine printer, indicia associated with a coin processing transaction before the initiation of the coin processing transaction or prior to a completion of a processing of a batch of coins in the self-service coin redemption machine to determine a redemption value thereof;
dispensing the substrate;
processing a batch of coins in the self-service coin redemption machine to determine a redemption value thereof;
transmitting the redemption value from the self-service coin redemption machine to an EPOS terminal using a communication device;
inputting the indicia printed on the substrate into the EPOS terminal using a data input device; and
verifying, using the EPOS terminal, that the indicia input into the EPOS terminal corresponds to an open transaction.

2. The method according to claim 1, further comprising:
dispensing cash, merchandise, or cash equivalent to the user in an amount corresponding to the redemption value when the indicia input into the EPOS terminal corresponds to an open transaction.

3. The method according to claim 1, further comprising:
closing the transaction associated with the indicia at least substantially contemporaneously with the act of dispensing.

4. The method according to claim 1, wherein the indicia is a randomly generated number or string or a user input number or string.

5. The method according to claim 1, further comprising:
displaying on a display a redemption value associated with the indicia.

6. The method according to claim 5, wherein the act of displaying occurs subsequent to the act of inputting the indicia into the EPOS terminal.

7. The method according to claim 5, wherein the act of displaying occurs contemporaneously with the processing of the batch of coins in the self-service coin redemption machine.

8. The method according to claim 1, wherein the act of inputting the indicia is performed by a cashier, teller, or attendant.

9. The method according to claim 2, wherein the act of inputting the indicia into the EPOS terminal is performed by the user.

10. The method according to claim 9, wherein the EPOS terminal is operatively associated with a kiosk.

11. The method according to claim 10, wherein the act of dispensing cash, merchandise, or cash equivalent to the user is performed by the kiosk.

12. The method according to claim 3, wherein the act of closing the transaction comprises altering or deleting of at least a portion of transaction information associated with the data or assigning a flag or state to the transaction information associated with the data.

13. The method according to claim 1, further comprising:
receiving a transaction record from the self-service coin processing machine, from the EPOS terminal, or from a cashier, teller, or attendant in association following completion of a redemption transaction.

14. A method of redeeming coins using a self-service coin redemption machine, the method comprising:
associating a substrate with a coin processing transaction before the initiation of the coin processing transaction or prior to a completion of a processing of a batch of coins in the self-service coin redemption machine to determine a redemption value thereof;
processing a batch of coins in the self-service coin redemption machine to determine a redemption value thereof;
transmitting the redemption value from the self-service coin redemption machine to an EPOS terminal using a communication device;
inputting information from the substrate using a data input device associated with the EPOS terminal; and
verifying, using the EPOS terminal, that the information read from the substrate corresponds to an open transaction.

15. The method according to claim 14, wherein the substrate comprises a RF tag and wherein the data input device comprises an RF tag reading device.

16. The method according to claim 15, wherein the self-service coin processing machine is configured to dispense the substrate to a user prior to, during, or following completion of the processing of the batch of coins.

17. The method according to claim 15, wherein the substrate is input by a user of the self-service coin processing machine prior to, during, or following completion of the processing of the batch of coins.

18. The method according to claim 14, wherein the data input device comprises one or more of a magnetic card reader, an IR reading device, a UV reading device, a touch screen, a key pad, or a keyboard.

19. A method of redeeming coins using a self-service coin processing machine, the method comprising:
receiving, via a data input device of a self-service coin processing machine, data input by a user in association with a coin processing transaction;
associating the data received from the user with a coin processing transaction;
processing, subsequent to the acts of receiving and associating, a batch of coins input into the self-service coin processing machine to determine a redemption value thereof;
transmitting the redemption value from the self-service coin processing machine to an EPOS device using a communication device;
inputting, via a data input device associated with the EPOS device, the data previously input by the user at the self-service coin processing machine in association with a coin processing transaction;
identifying the coin processing transaction corresponding to the data input by the user in association with the coin redemption transaction; and
verifying, using the EPOS device, that the data input into the EPOS device corresponds to an open transaction.

20. The method according to claim 19, further comprising:
dispensing cash, merchandise, or cash equivalent to the user in an amount corresponding to the redemption value when the data input into the EPOS terminal corresponds to an open transaction.

21. The method according to claim 21, further comprising:
closing the transaction associated with the data at least substantially contemporaneously with the act of dispensing.

22. The method according to claim 19, wherein the data is a randomly generated number or string or a user input number or string.

23. The method according to claim 19, wherein the data is a biometric input.

24. The method according to claim 19, further comprising:
displaying on a display a redemption value associated with the data.

25. The method according to claim 24, wherein the act of displaying occurs subsequent to the act of inputting the indicia into the EPOS terminal.

26. The method according to claim 24, wherein the act of displaying occurs contemporaneously with the processing of the batch of coins input into the self-service coin processing machine.

27. A method according to claim 19, wherein the act of inputting, via the data input device associated with the EPOS device, the data previously input by the user at the self-service coin processing machine is performed by a cashier, teller, or attendant.

28. The method according to claim 27, wherein the EPOS terminal is operatively associated with a kiosk.

29. The method according to claim 28, wherein the act of dispensing cash, merchandise, or cash equivalent to the user is performed by the kiosk.

30. A method according to claim 19, wherein the act of inputting, via the data input device associated with the EPOS device, the data previously input by the user at the self-service coin processing machine is performed by the user.

31. The method according to claim 30, wherein the EPOS terminal is operatively associated with a kiosk.

32. The method according to claim 31, wherein the act of dispensing cash, merchandise, or cash equivalent to the user is performed by the kiosk.

33. A method according to claim 21, wherein the act of closing the transaction comprises altering or deleting of at least a portion of transaction information associated with the data or assigning a flag or state to the transaction information associated with the data.

34. A system for redeeming coins comprising:
a self-service coin processing machine configured to process batches of input coins and to determine a redemption value thereof, the self-service coin processing machine comprising a controller, a display, a printing device, and a communication device, the controller being configured to generate a random number prior to or during a coin processing transaction, to cause the printing device to print the random number on a substrate and dispense the substrate bearing the random number to a user of the self-service coin processing machine prior to or during a coin processing transaction, to determine a redemption value of the input batch or batches of coins, and to cause the communication device to transmit the random number to an EPOS system in association with the transaction information comprising the redemption value, the EPOS system comprising a controller, a memory device, a communication device, and an EPOS terminal including a display device and a data input device,
wherein the EPOS system is configured to maintain in the EPOS system memory device a database comprising transaction information for open transactions, to receive data input into the data input device, to compare the data input into the data input device against the transaction information for open transactions maintained in the EPOS system memory device database, and to verify that the data input into the EPOS terminal data input device corresponds to an open transaction.

35. The system for redeeming coins according to claim 34, wherein the EPOS system is further configured to cause the EPOS terminal display device to display an instruction to a cashier, teller, or manager to dispense to the user bearing the substrate having the random number cash, merchandise, or cash equivalent in an amount corresponding to the redemption value when the data input into the EPOS terminal corresponds to an open transaction.

36. The system for redeeming coins according to claim 35, wherein the EPOS system controller is further configured to automatically close the transaction associated with the random number input to the EPOS system at least substantially contemporaneously with the causing of the EPOS terminal display device to display the instruction to the cashier, teller, or manager to dispense to the user bearing the substrate having the random number cash, merchandise, or cash equivalent in an amount corresponding to the redemption value.

37. A system for redeeming coins comprising:
a self-service coin processing machine configured to process batches of input coins and to determine a redemption value thereof, the self-service coin processing machine comprising a controller, a display, a printing device, a communication device, and a first data input device, the controller being configured to enable the processing of a batch of coins input by a user following input of user identification information by the user into the first data input device, the controller being further configured to cause the communication device to transmit the user identification information to an EPOS system, to determine a redemption value of the input batch or batches of coins, and to cause the communication device to transmit the redemption value to the EPOS system in association with the user identification information, the EPOS system comprising a controller, a memory device, a communication device, and an EPOS terminal including a display device and a second data input device,
wherein the EPOS system is configured to maintain in the EPOS system memory device a database comprising transaction information for open transactions, to receive user identification information input into the second data input device, to compare the user identification information input into the second data input device against the transaction information for open transactions maintained in the EPOS system memory device database, and to verify that the data input into the second data input device corresponds to an open transaction.

38. The system for redeeming coins according to claim 37, wherein the self-service coin processing machine controller is further configured to cause the printing device to print the user identification information on a substrate and dispense the substrate bearing the user identification information to a user of the self-service coin processing machine prior to or during a coin processing transaction.

39. The system for redeeming coins according to claim 37, wherein the user identification information is input into the second data input device by the user.

40. The system for redeeming coins according to claim 37, wherein the EPOS system is further configured to cause the EPOS terminal display device to display an instruction to a cashier, teller, or manager to dispense to the user cash, merchandise, or cash equivalent in an amount corresponding to the redemption value when the user identification information input into the second data input device corresponds to an open transaction.

41. The system for redeeming coins according to claim 37, wherein the EPOS system controller is further configured to automatically close the transaction associated with the user identification information input to the EPOS system at least substantially contemporaneously with the causing of the EPOS terminal display device to display the instruction to the cashier, teller, or manager to dispense to the user cash, merchandise, or cash equivalent in an amount corresponding to the redemption value.

42. The system for redeeming coins according to claim 37, further comprising a kiosk configured to dispense currency, wherein the EPOS terminal is integrated with the kiosk, and wherein the EPOS system is further configured to cause the kiosk to dispense to the user currency in an amount corresponding to the redemption value when the user identification information input into the second data input device corresponds to an open transaction.

43. The system for redeeming coins according to claim 37, wherein the first data input device and second data input device comprise biometric characteristic reading devices, and wherein the user identification information input by the user into the first data input device and the second data input device comprise a biometric characteristic.

44. A system for redeeming coins comprising:
a self-service coin processing machine configured to process batches of input coins and to determine a redemption value thereof, the self-service coin processing machine comprising a controller, a display, a printing device, and a communication device, the controller being configured to generate a random number following completion of a coin processing transaction, to determine a redemption value of the input batch or batches of coins, to cause the printing device to print the random number on a substrate and dispense the substrate bearing the random number to a user of the self-service coin following the completion of the coin processing transaction, to cause the communication device to transmit the random number to an EPOS system in association with transaction information comprising the redemption value, the EPOS system comprising a controller, a memory device, a communication device, and an EPOS terminal including a display device and a data input device,
wherein the EPOS system is configured to maintain in the EPOS system memory device a database comprising transaction information for open transactions, to receive data input into the data input device, to compare the data input into the data input device against the transaction information for open transactions maintained in the EPOS system memory device database, and to verify that the data input into the EPOS terminal data input device corresponds to an open transaction.
